(19) United States
(12) Patent Application Publication
(10) Pub. No.: US 2026/0365919 A1
(43) Pub. Date: Nov. 19, 2026

(54) ALKALINE EARTH METAL-BASED COMPLEX OXIDE, ITS PREPARATION AND USE

(71) Applicant: City University of Hong Kong, Kowloon (HK)

(72) Inventors: Feng Wang, Kowloon (HK); Yanze Wang, Kowloon (HK)

(21) Appl. No.: 19/204,925

(22) Filed: May 12, 2025

(51) Int. Cl. C09K 11/88; C01B 19/00

(52) U.S. Cl. CPC C09K 11/886; C01B 19/002; C01P 2002/54; C01P 2002/72; C01P 2002/76; C01P 2002/77; C01P 2002/82; C01P 2002/85; C01P 2004/03; C01P 2004/04; C01P 2004/61; C01P 2006/60

(57) ABSTRACT

An alkaline earth metal-based complex oxide having a general formula of AEZnOSe, wherein AE represents alkaline earth metals comprising Sr and Ca. Also addressed herein are: a method for preparing the alkaline earth metal-based complex oxide, particularly SrₓCa₁₋ₓZnOSe, where 0.01≤x≤0.99, (e.g., x is ≥0.4 and ≤0.6), and use of the alkaline earth metal-based complex oxide as a luminescent material responding to multiple stimuli.

### TECHNICAL FIELD

The present invention relates to an alkaline earth metal-based complex oxide, for example, particularly, but not exclusively, an alkaline earth metal-based complex oxide for hosting luminescent lanthanide ion dopants. The present invention also relates to a method for preparing the alkaline earth metal-based complex oxide and to the use of the alkaline earth metal-based complex oxide, particularly, as a luminescent material responding to multiple stimuli.

### BACKGROUND OF THE INVENTION

It is believed that near-infrared (NIR) light is promising for bioimaging and information technology due to its high penetration ability and resistance to interference with environment radiation. In practice, however, NIR-emissive materials may generally suffer from weak emission intensity and poor sustainability. This is believed to be particularly true in NIR-emissive systems involving host lattice and lanthanide dopants.

The invention thus seeks to eliminate or at least to mitigate such problems by providing a new or otherwise an improved material, particularly a host material for efficient NIR emission.

### SUMMARY OF THE INVENTION

In a first aspect of the present invention, there is provided an alkaline earth metal-based complex oxide having a general formula of AEZnOSe, wherein AE represents alkaline earth metals comprising Sr and Ca.

Optionally, AE represents SrₓCa₁₋ₓ, with x being an atomic ratio and 0≤x≤1. It is optional that 0.01≤x≤0.99. In an optional embodiment, 0.4≤x≤0.6.

Optionally, the SrₓCa₁₋ₓZnOSe with 0.4≤x≤0.6 has a single-phase crystal structure. It is optional that the SrₓCa₁₋ₓZnOSe with 0.4≤x≤0.6 has a non-centrosymmetric hexagonal lattice with a space group of P6₃mc.

In an optional embodiment, the alkaline earth metal-based complex oxide has a formula selected from the group consisting of: Sr_{0.4}Ca_{0.6}ZnOSe, Sr_{0.45}Ca_{0.55}ZnOSe, Sr_{0.5}Ca_{0.5}ZnOSe, Sr_{0.55}Ca_{0.45}ZnOSe, and Sr_{0.6}Ca_{0.4}ZnOSe.

Optionally, the alkaline earth metal-based complex oxide has an average particle size of about 25 μm to about 30 μm.

In an optional embodiment, the SrₓCa₁₋ₓZnOSe with 0.4≤x≤0.6 is doped with a lanthanide ion dopant.

Optionally, the SrₓCa₁₋ₓZnOSe with 0.4≤x≤0.6 is a host for receiving the lanthanide ion dopant.

It is optional that the lanthanide ion doped SrₓCa₁₋ₓZnOSe with 0.4≤x≤0.6 has a non-centrosymmetric hexagonal lattice.

Optionally, the SrₓCa₁₋ₓZnOSe with 0.4≤x≤0.6 is doped with about 0.2 mol % to about 1 mol % of the lanthanide ion dopant.

It is optional that the lanthanide ion dopant is selected from the group consisting of Nd³⁺, Yb³⁺, Er³⁺, Tm³⁺, Pr³⁺, Tb³⁺, Ho³⁺, Dy³⁺, and Sm³⁺.

Optionally, the lanthanide ion dopant is a NIR-emitting lanthanide ion dopant. It is optional that the NIR-emitting lanthanide ion dopant is selected from the group consisting of Nd³⁺, Yb³⁺, Er³⁺, Tm³⁺.

In a second aspect of the invention, there is provided a method for preparing the SrₓCa₁₋ₓZnOSe in accordance with the first aspect, comprising the step of reacting SrCO₃ and CaCO₃ and ZnSe in a solid-state reaction.

In an optional embodiment, the SrCO₃ and CaCO₃ are calcinated to form an intermediate comprising a Sr(Ca)O solid solution.

Optionally, the intermediate is formed in-situ by calcinating a mixture of ZnSe, SrCO₃ and CaCO₃.

It is optional that the mixture of ZnSe, SrCO₃ and CaCO₃ is calcinated at about 1000 °C to about 1350 °C for about 1 hour to about 4 hours, with a heating rate of about 5 °C min⁻¹ to about 10 °C min⁻¹.

In an optional embodiment, SrCO₃ and CaCO₃ are calcinated to form an intermediate and the intermediate is calcinated with ZnSe to form SrₓCa₁₋ₓZnOSe, where 0.01≤x≤0.99. Optionally, x is ≥0.4 and ≤0.6.

Optionally, the SrCO₃ and CaCO₃ are calcinated at about 1000 °C to about 1350 °C for about 1 hour to about 4 hours.

It is optional that the intermediate and ZnSe are calcinated at about 1000 °C to about 1350 °C for about 1 hour to about 4 hours, with a heating rate of about 5 °C min⁻¹ to about 10 °C min⁻¹.

Optionally, the solid-state reaction is performed without a fluxing agent.

In an optional embodiment, the ZnSe, SrCO₃, CaCO₃, and an oxide of a lanthanide ion are calcinated to form a lanthanide-doped SrₓCa₁₋ₓZnOSe, where 0.4≤x≤0.6.

Optionally, the lanthanide ion is selected from the group consisting of Nd³⁺, Yb³⁺, Er³⁺, Tm³⁺, Pr³⁺, Tb³⁺, Ho³⁺, Dy³⁺, and Sm³⁺.

It is optional that the lanthanide ion has a concentration of about 0.2 mol % to about 1 mol %.

Optionally, the mixture of ZnSe, SrCO₃ CaCO₃, and the oxide of the lanthanide ion is calcinated at about 1000 °C to about 1350 °C for about 1 hour to about 4 hours, with a heating rate of about 5 °C min⁻¹ to about 10 °C min⁻¹.

In a third aspect of the present invention, there is provided a luminescent material that is responsive to multiple stimuli, comprising a host including an alkaline earth metal-based complex oxide having a general formula of AEZnOSe, wherein AE represents alkaline earth metals comprising Sr and Ca; and the host is doped with a lanthanide ion dopant.

It is optional that AEZnOSe is SrₓCa₁₋ₓZnOSe, where 0.4≤x≤0.6.

Optionally, the host and the dopant has a formula of Sr_{0.6}Ca_{0.4}ZnOSe:Ln³⁺. Optionally, Ln³⁺ is selected from the group consisting of Nd³⁺, Yb³⁺, Er³⁺, Tm³⁺, Pr³⁺, Tb³⁺, Ho³⁺, Dy³⁺, and Sm³⁺.

In an optional embodiment, the alkaline earth metal-based complex oxide comprises SrₓCa₁₋ₓZnOSe which is doped with about 0.2 mol % to about 1 mol % of the Nd³⁺.

Optionally, the alkaline earth metal-based complex oxide comprises SrₓCa₁₋ₓZnOSe which is doped with Ln³⁺, generates photoluminescence at about 480 nm to about 1540 nm in response to radiation stimuli at about 350 nm to about 360 nm.

In an optional embodiment, the Sr_{0.6}Ca_{0.4}ZnOSe:Ln³⁺ is encapsulated by a transparent material selected from the group consisting of polyethylene terephthalate (PET), polydimethylsiloxane (PDMS), dibutyl phthalate (DBP), and a combination thereof.

It is optional that the Sr_{0.6}Ca_{0.4}ZnOSe:Ln³⁺ being encapsulated by the transparent material generates mechanoluminescence at about 480 nm to about 1540 nm in response to applied mechanical force of about 5 N to about 55 N.

Optionally, intensity of the mechanoluminescence is positively proportional to the applied mechanical force.

It is optional that the mechanoluminescence is detectable through a biological tissue with a thickness of about 2 mm to about 8 mm.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1 shows the schematic illustration of the crystal structure of SrZnOSe;

FIG. 2 shows the XRD patterns of the products prepared using binary mixtures of SrCO₃ and CaCO₃ at different mole ratios as the alkaline-earth source;

FIG. 3A shows the XRD patterns of products obtained by calcinating ZnSe with alkaline-earth carbonates at different Sr/Ca ratios;

FIG. 3B shows the XRD patterns of products obtained by calcinating ZnSe with alkaline-earth carbonates at different Sr/Ca ratios;

FIG. 3C shows the ratios of the impurity phases in the as-prepared samples from quantitative phase analysis based on the XRD patterns in FIGS. 2, 3A and 3B;

FIG. 4 shows the Rietveld refinement of the XRD pattern of Sr_{0.6}Ca_{0.4}ZnOSe;

FIG. 5 shows the comparison of XRD patterns of as-prepared Sr_{0.6}Ca_{0.4}ZnOSe (top panel) with CaZnOS (mid panel) and SrZnOS (bottom panel);

FIG. 6 shows the schematic illustration of the crystal structures of Sr_{0.6}Ca_{0.4}ZnOSe (left) and CaZnOS (right);

FIG. 7 is a table summarizing the comparison of unit cell parameters of Sr_{0.6}Ca_{0.4}ZnOSe and CaZnOS crystals obtained from Rietveld refinement;

FIG. 8 shows the XRD patterns of the intermediate product obtained by calcining SrCO₃ and CaCO₃ (top panel) and the final product obtained by further calcining the intermediate product with ZnSe (bottom panel);

FIG. 9A shows the XRD patterns of Sr_{0.6}Ca_{0.4}ZnOSe synthesized without and with the assistance of the fluxing agent LiNO₃;

FIG. 9B shows the comparison of XRD patterns of mixed raw materials (top) and bare ZnSe (bottom) after calcination in ambient atmosphere;

FIG. 9C shows the XRD patterns of the Sr_{0.6}Ca_{0.4}ZnOSe synthesized at different temperatures for 3 h;

FIG. 9D shows the XRD patterns of the Sr_{0.6}Ca_{0.4}ZnOSe synthesized at 1000 °C for different reaction times;

FIG. 10 shows the SEM image of the as-synthesized Sr_{0.6}Ca_{0.4}ZnOSe crystals (left) and EDX elemental mapping of a single particle (right);

FIG. 11 shows the EDX (left) and XPS (right) spectra of the as-synthesized Sr_{0.6}Ca_{0.4}ZnOSe crystals;

FIG. 12 shows the high-resolution STEM image taken at the incidence of a Sr_{0.6}Ca_{0.4}ZnOSe crystal section and the corresponding fast Fourier-transform diffractogram;

FIG. 13 shows the band structure and electronic density of state (DOS) of Sr_{0.6}Ca_{0.4}ZnOSe crystal;

FIG. 14 shows the absorption spectra of the Sr_{0.6}Ca_{0.4}ZnOSe crystal. The inset shows the Tauc plot and the estimated optical bandgap;

FIG. 15A shows the Rietveld refinement of the XRD patterns of Sr_{0.6}Ca_{0.4}ZnOSe doped with 0.2 mol % of Nd³⁺. The changes in the relative peak intensities of the XRD data may be ascribed to lattice imperfections induced by Nd³⁺ doping;

FIG. 15B shows the Rietveld refinement of the XRD patterns of Sr_{0.6}Ca_{0.4}ZnOSe doped with 0.4 mol % of Nd³⁺. The changes in the relative peak intensities of the XRD data may be ascribed to lattice imperfections induced by Nd³⁺ doping;

FIG. 15C shows the Rietveld refinement of the XRD patterns of Sr_{0.6}Ca_{0.4}ZnOSe doped with 0.6 mol % of Nd³⁺. The changes in the relative peak intensities of the XRD data may be ascribed to lattice imperfections induced by Nd³⁺ doping;

FIG. 15D shows the Rietveld refinement of the XRD patterns of Sr_{0.6}Ca_{0.4}ZnOSe doped with 0.8 mol % of Nd³⁺. The changes in the relative peak intensities of the XRD data may be ascribed to lattice imperfections induced by Nd³⁺ doping;

FIG. 15E shows the Rietveld refinement of the XRD patterns of Sr_{0.6}Ca_{0.4}ZnOSe doped with 1 mol % of Nd³⁺. The changes in the relative peak intensities of the XRD data may be ascribed to lattice imperfections induced by Nd³⁺ doping;

FIG. 15F shows the XRD-derived volumes of [Sr(Ca)O₃Se₃] as functions of Nd³⁺ doping concentrations. Inset is the schematic diagram of the coordination environments of Sr²⁺ (Ca²⁺);

FIG. 16A shows the EDX spectrum (left) with the corresponding HAADF-STEM image (left, inert) and EDX mapping (right) of a Sr_{0.6}Ca_{0.4}ZnOSe:Nd³⁺ (1 mol %) crystal section (left, inset);

FIG. 16B shows the XPS survey of Sr_{0.6}Ca_{0.4}ZnOSe:Nd³⁺ (1 mol %) and the corresponding high-resolution spectrum of Nd³⁺ (inset);

FIG. 17 shows the density-functional theory calculated phonon dispersion curves of Sr_{0.6}Ca_{0.4}ZnOSe (left) and CaZnOS (right) crystals;

FIG. 18 shows the comparison between Raman spectra of Sr_{0.6}Ca_{0.4}ZnOSe:Nd³⁺ (0.4 mol %, top) and CaZnOS:Nd³⁺ (0.4 mol %, bottom) crystals. Insets are the schematic diagram of the coordination environments of Sr/Ca and Zn ions;

FIG. 19 shows the Raman spectra of Sr_{0.6}Ca_{0.4}ZnOSe (left) and CaZnOS (right) doped with different concentrations of Nd³⁺ from 0 to 1 mol %. The peak broadening in the Raman data upon Nd³⁺ doping may be ascribed to local lattice distortion;

FIG. 20 shows the excitation (dot line) and emission (solid line) spectra of Sr_{0.6}Ca_{0.4}ZnOSe:Nd³⁺ (0.4 mol %) and CaZnOS:Nd³⁺ (0.4 mol %);

FIG. 21A shows the comparison of the excitation and emission spectra of Nd³⁺ doped Sr_{0.6}Ca_{0.4}ZnOSe under host sensitization at doping concentrations of 0.2, 0.4, 0.6, 0.8, and 1 mol %;

FIG. 21B shows the comparison of the excitation and emission spectra of Nd³⁺ doped CaZnOS under host sensitization at doping concentrations of 0.2, 0.4, 0.6, 0.8, and 1 mol %;

FIG. 22 shows the schematic energy level diagram of Nd³⁺;

FIG. 23 shows the comparison of decay lifetimes between Sr_{0.6}Ca_{0.4}ZnOSe:Nd³⁺ (0.4 mol %) and CaZnOS:Nd³⁺ (0.4 mol %) under host excitation monitored at 918 nm;

FIG. 24A shows the comparison of the host excited decay curves of Nd³⁺ at doping concentrations of 0.2, 0.4, 0.6, 0.8, and 1 mol % in Sr_{0.6}Ca_{0.4}ZnOSe with Ex358/Em918. The white lines are fitted curves;

FIG. 24B shows the comparison of the host excited decay curves of Nd³⁺ at doping concentrations of 0.2, 0.4, 0.6, 0.8, and 1 mol % in Sr_{0.6}Ca_{0.4}ZnOSe with Ex358/Em1108. The white lines are fitted curves;

FIG. 24C shows the comparison of the host excited decay curves of Nd³⁺ at doping concentrations of 0.2, 0.4, 0.6, 0.8, and 1 mol % in CaZnOS with Ex292/Em918. The white lines are fitted curves;

FIG. 24D shows the comparison of the host excited decay curves of Nd³⁺ at doping concentrations of 0.2, 0.4, 0.6, 0.8, and 1 mol % in CaZnOS with Ex292/Em1108. The white lines are fitted curves;

FIG. 25 is a table summarizing the lifetime decay parameters and calculated average lifetimes of Nd³⁺ at doping concentrations of 0.2, 0.4, 0.6, 0.8, and 1 mol % in Sr_{0.6}Ca_{0.4}ZnOSe and CaZnOS;

FIG. 26A shows the comparison of the excitation and emission spectra of Tm³⁺ in Sr_{0.6}Ca_{0.4}ZnOSe under the host sensitization;

FIG. 26B shows the comparison of the excitation and emission spectra of Tm³⁺in CaZnOS under the host sensitization;

FIG. 26C shows the comparison of the decay curves of Tm³⁺ in Sr_{0.6}Ca_{0.4}ZnOSe and CaZnOS under the host sensitization;

FIG. 27A shows the comparison of the excitation and emission spectra of Yb³⁺ in Sr_{0.6}Ca_{0.4}ZnOSe under the host sensitization;

FIG. 27B shows the comparison of the excitation and emission spectra of Yb³⁺ in CaZnOS under the host sensitization;

FIG. 27C shows the comparison of the decay curves of Yb³⁺ in Sr_{0.6}Ca_{0.4}ZnOSe and CaZnOS under the host sensitization;

FIG. 28A shows the comparison of the excitation and emission spectra of Er³⁺ in Sr_{0.6}Ca_{0.4}ZnOSe in the NIR region under the host sensitization;

FIG. 28B shows the comparison of the excitation and emission spectra of Er³⁺ in CaZnOS in the NIR region under the host sensitization;

FIG. 28C shows the comparison of the decay curves of Er³⁺ in Sr_{0.6}Ca_{0.4}ZnOSe and CaZnOS in the NIR region under the host sensitization;

FIG. 29A shows the comparison of the excitation and emission spectra of Pr³⁺ in Sr_{0.6}Ca_{0.4}ZnOSe under the host sensitization;

FIG. 29B shows the comparison of the excitation and emission spectra of Pr³⁺ in CaZnOS under the host sensitization. It is believed that the slightly inferior visible emissions in Sr_{0.6}Ca_{0.4}ZnOSe relative to CaZnOS may be attributed to the quenching effects of inter-band transitions;

FIG. 29C shows the comparison of the decay curves of Pr³⁺ in Sr_{0.6}Ca_{0.4}ZnOSe and CaZnOS under the host sensitization;

FIG. 30A shows the comparison of the excitation and emission spectra of Tb³⁺ in Sr_{0.6}Ca_{0.4}ZnOSe under the host sensitization;

FIG. 30B shows the comparison of the excitation and emission spectra of Tb³⁺ in CaZnOS under the host sensitization. It is believed that the slightly inferior visible emissions in Sr_{0.6}Ca_{0.4}ZnOSe relative to CaZnOS may be attributed to the quenching effects of inter-band transitions;

FIG. 30C shows the comparison of the decay curves of Tb³⁺ in Sr_{0.6}Ca_{0.4}ZnOSe and CaZnOS under the host sensitization;

FIG. 31A shows the comparison of the excitation and emission spectra of Er³⁺ in Sr_{0.6}Ca_{0.4}ZnOSe in the visible region under the host sensitization;

FIG. 31B shows the comparison of the excitation and emission spectra of Er³⁺ in CaZnOS in the visible region under the host sensitization. It is believed that the low phonon energy of Sr_{0.6}Ca_{0.4}ZnOSe compensated for the quenching of the excited state, leading to a similar visible emission intensity as CaZnOS;

FIG. 31C shows the comparison of the decay curves of Er³⁺ in Sr_{0.6}Ca_{0.4}ZnOSe and CaZnOS in the visible region under the host sensitization;

FIG. 32 is a table summarizing the lifetime decay parameters and calculated average lifetimes of Tm³⁺, Yb³⁺, Pr³⁺, Tb³⁺, and Er³⁺ at doping concentrations of 1 mol % in Sr_{0.6}Ca_{0.4}ZnOSe and CaZnOS;

FIG. 33 is a schematic diagram illustrating an exemplary instrument for ML measurements. A mechanical control unit, including linear motors and a pressure gauge, was used to provide quantitative mechanical excitation to the system;

FIG. 34 shows the photograph (top) and structure (bottom) of the Sr_{0.6}Ca_{0.4}ZnOSe:Nd³⁺ (0.4 mol %) sealed with PDMS in a flexible PET film;

FIG. 35 shows the comparison of ML intensity of Sr_{0.6}Ca_{0.4}ZnOSe:Nd³⁺ (0.4 mol %) and CaZnOS:Nd³⁺ (0.4 mol %) under mechanical excitation at 30 N. Inset shows the visualization of handwriting trajectory through long-time exposure using Sr_{0.6}Ca_{0.4}ZnOSe:Nd³⁺ (0.4 mol %);

FIG. 36A shows the comparison of the ML spectra of Nd³⁺ at doping concentrations of 0.2, 0.4, 0.6, 0.8, and 1 mol % in Sr_{0.6}Ca_{0.4}ZnOSe under an applied force of 30 N;

FIG. 36B shows the comparison of the ML spectra of Nd³⁺ at doping concentrations of 0.2, 0.4, 0.6, 0.8, and 1 mol % in CaZnOSe under an applied force of 30 N;

FIG. 37 shows the normalized in-situ Raman spectra of Sr_{0.6}Ca_{0.4}ZnOSe:Nd³⁺ (0.4 mol %) (left) and CaZnOS:Nd³⁺ (0.4 mol %) (right) crystals as a function of pressure. SrZnOSe features consistently low phonon energy under pressure, in contrast to slightly increased phonon energy in CaZnOS crystals upon compression. It is believed that the observation is probably due to the relatively long chemical bonds in SrZnOSe, which can help accommodate the external stress;

FIG. 38A shows the comparison of the ML spectra of Tm³⁺ at doping concentrations of 0.2, 0.4, 0.6, 0.8, and 1 mol % in Sr_{0.6}Ca_{0.4}ZnOSe under an applied force of 30 N;

FIG. 38B shows the comparison of the ML spectra of Yb³⁺ at doping concentrations of 0.2, 0.4, 0.6, 0.8, and 1 mol % in Sr_{0.6}Ca_{0.4}ZnOSe under an applied force of 30 N;

FIG. 38C shows the comparison of the ML spectra of Er³⁺ at doping concentrations of 0.2, 0.4, 0.6, 0.8, and 1 mol % in Sr_{0.6}Ca_{0.4}ZnOSe under an applied force of 30 N;

FIG. 39A shows the ML spectra of Er³⁺-doped Sr_{0.6}Ca_{0.4}ZnOSe at doping concentrations of 0.2, 0.4, 0.6, 0.8, and 1 mol % under an applied force of 30 N;

FIG. 39B shows the ML spectra of Pr³⁺-doped Sr_{0.6}Ca_{0.4}ZnOSe at doping concentrations of 0.2, 0.4, 0.6, 0.8, and 1 mol % under an applied force of 30 N;

FIG. 39C shows the ML spectra of Tb³⁺-doped Sr_{0.6}Ca_{0.4}ZnOSe at doping concentrations of 0.2, 0.4, 0.6, 0.8, and 1 mol % under an applied force of 30 N;

FIG. 39D shows the ML spectra of Ho³⁺-doped Sr_{0.6}Ca_{0.4}ZnOSe at doping concentrations of 0.2, 0.4, 0.6, 0.8, and 1 mol % under an applied force of 30 N;

FIG. 39E shows the ML spectra of Dy³⁺-doped Sr_{0.6}Ca_{0.4}ZnOSe at doping concentrations of 0.2, 0.4, 0.6, 0.8, and 1 mol % under an applied force of 30 N;

FIG. 39F shows the ML spectra of Sm³⁺-doped Sr_{0.6}Ca_{0.4}ZnOSe at doping concentrations of 0.2, 0.4, 0.6, 0.8, and 1 mol % under an applied force of 30 N;

FIG. 40A shows the integral ML intensity of Sr_{0.6}Ca_{0.4}ZnOSe:Nd³⁺ (0.4 mol %) versus applied force in the range of 5-55 N;

FIG. 40B shows the ML spectra of Sr_{0.6}Ca_{0.4}ZnOSe:Nd³⁺ (0.4 mol %) versus applied force in the range of 5-55 N;

FIG. 41A shows the repeatability of composite films under continuous mechanical excitation at 30 N for 10 cycles at room temperature;

FIG. 41B shows the repeatability of composite films under continuous mechanical excitation at 30 N;

FIG. 42A shows the XRD patterns of Sr_{0.6}Ca_{0.4}ZnOSe:Nd³⁺ (0.4 mol %) before and after 5 months of storage. Although some minor peaks emerged in the XRD pattern after storage, probably caused by water absorption, the original phase could be fully recovered by heat treatment at 80 °C for 20 min;

FIG. 42B shows the ML signals of the recovered samples under continuous mechanical excitation at 30 N, indicating good durability;

FIG. 43A shows the in vitro cytotoxicity of Sr_{0.6}Ca_{0.4}ZnOSe particles against KYSE150 cells after 24 h incubation at 37 °C;

FIG. 43B shows the in vitro cytotoxicity of Sr_{0.6}Ca_{0.4}ZnOSe particles against HUVEC cells after 24 h incubation at 37 °C;

FIG. 44 shows the 3D TL emission spectrum of Sr_{0.6}Ca_{0.4}ZnOSe:Nd³⁺ (0.4 mol %) by monitoring 500-1100 nm emissions in the temperature range from 300 to 500 K;

FIG. 45 shows the effect of UV irradiation and heating on the integral ML intensity of the Sr_{0.6}Ca_{0.4}ZnOSe:Nd³⁺ (0.4 mol %, top) and the cyclic stability under continuous mechanical excitation at 403 K (bottom). The applied force was fixed at 30N;

FIG. 46A shows the effect of UV irradiation and heating (313 to 403 K) on the ML performance of Sr_{0.6}Ca_{0.4}ZnOSe:Nd³⁺ (0.4 mol %);

FIG. 46B shows the effect of heating on the cyclic stability of Sr_{0.6}Ca_{0.4}ZnOSe:Nd³⁺ (0.4 mol %) at 403 K;

FIG. 47 shows the photograph and structure of an occlusal mouthguard containing prepared phosphors;

FIG. 48 shows the ML spectra recorded through tissues of different thicknesses (0-8 mm) for a mouthguard comprising Sr_{0.6}Ca_{0.4}ZnOSe:Nd³⁺ (0.4 mol %);

FIG. 49 shows the photograph of an exemplary instrument used for ML measurements, in which a slice of pork mimicking human oral tissues was placed between a transparent sample-fixing plate and the optical fiber. A pressure gauge was used to simulate the bite force applied to the mouthguard. The thickness of pork was varied from 2 mm (left) to 8 mm (right);

FIG. 50 shows the ML spectra recorded through tissues of different thicknesses (0-8 mm) for a mouthguard comprising Sr_{0.6}Ca_{0.4}ZnOSe:Er³⁺ (1 mol %). It is noted that a higher external force was applied to Sr_{0.6}Ca_{0.4}ZnOSe:Er³⁺ (150 N) than Sr_{0.6}Ca_{0.4}ZnOSe:Nd³⁺ (30 N) to render comparable emission intensities;

FIG. 51 is schematic diagram illustrating an oral cavity model illustrating the generation of dash (-) and dot (·) in Morse code for encrypted optical signaling;

FIG. 52 shows the NIR ML images captured at molars and incisors by continuous bites of the mouthguard in prescribed patterns; and

FIG. 53 shows the NIR signals at molars and incisors collected under occlusal stress, respectively. It is noted that the brighter ML signals in the molar area resulted from the stronger bite force.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

Various strategies have been proposed to enhance the near-infrared (NIR) performance of host-lanthanide dopant systems. For example, in the case of CaZnOS:Nd³⁺, one approach involves co-doping with Mn²⁺ and Nd³⁺ to the CaZnOS host lattice, which enhances the NIR emission by approximately 2.6-fold due to Mn²⁺-to-Nd³⁺ energy transfer (ET). Another approach is using a LiF-assisted solid-state reaction to improve the host crystallinity and Nd³⁺ doping efficiency, thereby boosting the Nd³⁺ emission. However, these approaches may not fully address the inherent low NIR emission efficiency caused by the host lattice, which is believed to have high vibrational energy, leading to quenching of the lanthanide dopants through multiphonon emissions.

Without wishing to be bound by theory, the inventors have, through their own research, trials, and experiments, devised a heavy-element host in form of complex oxide, such as an alkaline earth metal-based complex oxide with heavy element(s), that may significantly mitigate the quenching process due to reduced phonon energies (e.g., ≈220 cm⁻¹). It is believed that the host material as described herein may render much brighter NIR emissions after doping with various lanthanide activators, thereby enabling various photonic applications, such as encrypted optical communication in biological environments as demonstrated in some embodiments of the present disclosure.

In a first aspect of the present invention, there is provided an alkaline earth metal-based complex oxide having a general formula of AEZnOSe, wherein AE represents alkaline earth metals comprising Sr and Ca. In particular, it is believed that by having two or more alkaline earth metals in the complex oxide, it may result in more cation sites for accommodating diverse dopant ions for flexible optical tuning.

In some embodiments, AE may represent SrₓCa₁₋ₓ, with x being an atomic ratio and 0<x<1. In some particular embodiments, x may be ≥0.01 and ≤0.99, such as 0.01, 0.02 . . . 0.1 . . . 0.12 . . . 0.3 . . . 0.35 . . . 0.4 . . . 0.44 . . . 0.55 . . . 0.6 . . . 0.99 and the like. In some more particular embodiments, x may be ≥0.4 and ≤0.6. Without wishing to be bound by theory, the inventors have devised that the alkaline earth metal-based complex oxide SrₓCa₁₋ₓZnOSe with 0.4≤x≤0.6 may have a pure, single-phase crystal structure, particularly a non-centrosymmetric hexagonal lattice with a space group of P6₃mc. In addition, it is devised that the SrₓCa₁₋ₓZnOSe with 0.43≤x≤0.6 may have an average particle size of about 25 μm to about 30 μm, such as about 25 μm (e.g., 24.5 μm . . . 24.55 μm . . . 24.6 μm . . . 24.72 μm . . . 24.8 μm . . . 25 μm . . . 25.01 μm . . . 25.23 μm and the like), with irregular shape and rough surface.

As some specific embodiments, the SrₓCa₁₋ₓZnOSe with 0.4≤x≤0.6 may have a formula selected from the group consisting of: Sr_{0.4}Ca_{0.6}ZnOSe, Sr_{0.45}Ca_{0.55}ZnOSe, Sr_{0.5}Ca_{0.5}ZnOSe, Sr_{0.55}Ca_{0.45}ZnOSe, and Sr_{0.6}Ca_{0.4}ZnOSe.

As mentioned herein, the alkaline earth metal-based complex oxide of the present invention may have a low phonon energy, which may be reflected by the Raman cut-off wavenumber of about 215 cm⁻¹ to about 225 cm⁻¹, such as about 220 cm⁻¹. Without wishing to be bound by theory, it is believed that with such a low phonon energy, the alkaline earth metal-based complex oxide as described herein, particularly the SrₓCa₁₋ₓZnOSe with 0.4≤x≤0.6, may be suitable for hosting lanthanide activators.

Accordingly, in some embodiments, the SrₓCa₁₋ₓZnOSe with 0.4≤x≤0.6 may be a doped SrₓCa₁₋ₓZnOSe, particularly a lanthanide ion dopant-doped, more particularly a NIR-emitting lanthanide ion dopant-doped or a visible light-emitting lanthanide ion dopant-doped SrₓCa₁₋ₓZnOSe with 0.4≤x≤0.6, and may have a formula of SrₓCa₁₋ₓZnOSe:Ln³⁺. The SrₓCa₁₋ₓZnOSe with 0.4≤x≤0.6 may be a host for receiving the lanthanide ion dopant (the NIR-emitting lanthanide ion dopant or the visible light-emitting lanthanide ion dopant). In particular, the lanthanide ion dopant may be doped to the SrₓCa₁₋ₓZnOSe host lattice by substituting for Sr³⁺ or Ca²⁺ in the host lattice, and may be accompanied by a gradual reduction in the volume of the [Sr(Ca)O₃Se₃] polyhedron. Unexpectedly, it is devised that the lanthanide ion-doped SrₓCa₁₋ₓZnOSe with 0.4≤x≤0.6 may have a non-centrosymmetric hexagonal lattice, which is consistent with that of the SrₓCa₁₋ₓZnOSe with 0.43≤x≤0.6. As used herein, the NIR-emitting lanthanide ion dopant may generally denote Nd³⁺, Yb³⁺, Er³⁺, and Tm³⁺; whereas the visible light-emitting lanthanide ion dopant may generally denote Pr³⁺, Tb³⁺, Ho³⁺, Dy³⁺, and Sm³⁺.

In some embodiments, the SrₓCa₁₋ₓZnOSe with 0.4≤x≤0.6 may be doped with about 0.2 mol % to about 1 mol % (e.g., 0.18 mol % to 1.05 mol %, 0.18 mol % to 1.09 mol %, 0.18 mol % to 1 mol %, 0.19 mol % to 1 mol %, 0.19 mol % to 0.99 mol %, 0.18 mol % to 1.1 mol %, 0.19 mol % to 1.1 mol %, 0.21 mol % to 1 mol %, 0.21 mol % to 1.1 mol %, and the like) of the lanthanide ion dopant. In some particular embodiments, the SrₓCa₁₋ₓZnOSe with 0.4≤x≤0.6 may be doped with 0.2 mol %, 0.4 mol %, 0.6 mol %, 0.8 mol %, or 1 mol % of the lanthanide ion dopant.

The lanthanide ion dopant may be selected from the group consisting of Nd³⁺, Yb³⁺, Er³⁺, Tm³⁺, Pr³⁺, Tb³⁺, Ho³⁺, Dy³⁺, and Sm³⁺. Accordingly, in these embodiments, the lanthanide ion doped SrₓCa₁₋ₓZnOSe with 0.4≤x≤0.6 may have a formula selected from the group consisting of SrₓCa₁₋ₓZnOSe:Nd³⁺, SrₓCa₁₋ₓZnOSe:Yb³⁺, SrₓCa₁₋ₓZnOSe:Er³⁺, SrₓCa₁₋ₓZnOSe:Tm³⁺, SrₓCa₁₋ₓZnOSe:Pr³⁺, SrₓCa₁₋ₓZnOSe:Tb³⁺, SrₓCa₁₋ₓZnOSe:Ho³⁺, SrₓCa₁₋ₓZnOSe:Dy³⁺, and SrₓCa₁₋ₓZnOSe:Sm³⁺.

The method for preparing the SrₓCa₁₋ₓZnOSe, where 0≤x≤1 will now be disclosed. The method may comprise the step of reacting SrCO₃ and CaCO₃ with ZnSe in a solid-state reaction. Without wishing to be bound by theory, the inventors have devised that by using both the SrCO₃ and CaCO₃ as the starting materials, it may allow to tune the reaction process through Ca alloying. In particular, it is believed the SrCO₃ and CaCO₃ may be calcinated such that Ca would be introduced, forming a Sr(Ca)O intermediate phase, such as a Sr(Ca)O solid solution, with reduced displacement reactivity toward ZnSe, thereby facilitating the reaction between alkaline earth oxides and ZnSe to yield the target product SrₓCa₁₋ₓZnOSe, where 0.01≤x≤0.99, such as x is ≥0.4 and ≤0.6.

In some embodiments, the preparation of the SrₓCa₁₋ₓZnOSe may be a one-pot process, in which the intermediate is formed in-situ by calcinating a mixture of ZnSe, SrCO₃ and CaCO₃. The mixture of ZnSe, SrCO₃ and CaCO₃ may be calcinated at about 1000 °C to about 1350 °C (e.g., 978 °C to 1350 °C, 980 °C to 1360 °C, 978 °C to 1370 °C, 984 °C to 1370 °C, 989 °C to 1350 °C, 990 °C to 1370 °C, 992 °C to 1350 °C, 1005 °C to 1350 °C, 1020 °C to 1370 °C and the like) for about 1 hour to about 4 hours (e.g., 0.8 . . . 0.85 . . . 0.9 . . . 1 . . . 1.5 . . . 1.8 . . . 2 . . . 4 hour and the like), with a heating rate of about 5 °C min⁻¹ to about 10 °C min⁻¹ (e.g., 4.5 . . . 4.7 . . . 5 . . . 5.1 . . . 5.5 . . . 7.1 . . . 7.5 . . . 8 . . . 9.6 . . . 10 . . . 10.2 . . . 10.3 . . . 10.5 °C min⁻¹ and the like).

In some embodiments, the preparation of the SrₓCa₁₋ₓZnOSe may be separated into to multiple steps, such as two or more steps. For example, in some embodiments, the SrCO₃ and CaCO₃ may be calcinated to form the intermediate and the intermediate may then be calcinated with ZnSe to form SrₓCa₁₋ₓZnOSe, where 0.01≤x≤0.99 such as x is ≥0.4 and ≤0.6. In particular, the SrCO₃ and CaCO₃ are calcinated at about 1000 °C to about 1350 °C for about 1 hour to about 4 hours to form the intermediate. After that, the intermediate and ZnSe may be calcinated at about 1000 °C to about 1350 °C for about 1 hour to about 4 hours as described herein, with a heating rate of about 5 °C min⁻¹ to about 10 °C min⁻¹.

The method as described herein is advantageous that the reaction is performed without a fluxing agent such as LiNO₃. Without wishing to be bound by theory, it is believed that the presence of the fluxing agent may promote the displacement reactions between ZnSe and any intermediate phases, leading to impurity phase such as Ca/SrSe and ZnO in the target product. Thus, it is preferred that the method as described herein is performed without a fluxing agent.

Without wishing to be bound by theory, the method as described herein is suitable for preparing lanthanide-doped SrₓCa₁₋ₓZnOSe, particularly the lanthanide-doped SrₓCa₁₋ₓZnOSe (i.e., SrₓCa₁₋ₓZnOSe:Ln³⁺) as described herein. In these embodiments, the ZnSe, SrCO₃, CaCO₃, and an oxide of a lanthanide ion may be calcinated to form a lanthanide-doped SrₓCa₁₋ₓZnOSe, where 0.4≤x≤0.6. In particular, the mixture of ZnSe, SrCO₃ CaCO₃, and the oxide of the lanthanide ion may be calcinated at about 1000 °C to about 1350 °C as described herein for about 1 hour to about 4 hours, with a heating rate of about 5 °C min⁻¹ to about 10 °C min⁻¹.

The lanthanide ion may be selected from those as described herein, such as from the group consisting of Nd³⁺, Yb³⁺, Er³⁺, Tm³⁺, Pr³⁺, Tb³⁺, Ho³⁺, Dy³⁺, and Sm³⁺.

In some embodiments, the lanthanide ion may have a concentration of about 0.2 mol % to about 1 mol % such as 0.17 mol % to 1 mol %, 0.17 mol % to 1.05 mol %, 0.17 mol % to 1.1 mol %, 0.17 mol % to 0.99 mol %, 0.17 mol % to 0.98 mol %, 0.18 mol % to 1 mol %, 0.18 mol % to 1.08 mol %, 0.19 mol % to 1 mol %, 0.19 mol % to 0.99 mol %, 0.2 mol % to 1.02 mol %, 0.2 mol % to 1.1 mol %, 0.2 mol % to 0.99 mol %, and the like.

As used in the method as described herein, the starting materials, such as ZnSe, SrCO₃ CaCO₃, and the oxide of the lanthanide ion as described herein may be particularly in powder form. The powder of the starting materials may be prepared by grinding them. For example, a mixture of the starting materials may be grinded in an agate mortar for e.g. about 5 mins, with the aid of a suitable solvent such as ethanol. After grinding, the mixture may be dried under an elevated temperature such as about 60 °C before being transferred for calcination.

Optionally or additionally, the as-prepared SrₓCa₁₋ₓZnOSe and lanthanide-doped SrₓCa₁₋ₓZnOSe as described herein may be ground in an agate mortar prior to further use.

In a third aspect of the present invention, there is provided a luminescent material that is responsive to multiple stimuli, comprising a host including an alkaline earth metal-based complex oxide having a general formula of AEZnOSe as described herein, wherein AE represents alkaline earth metals comprising Sr and Ca; and the host is doped with a lanthanide ion dopant.

In some particular embodiments, the AEZnOSe may be SrₓCa₁₋ₓZnOSe, where 0.4≤x≤0.6. For example, the host and the dopant may have a formula of SrₓCa₁₋ₓZnOSe:Ln³⁺, where Ln³⁺ is selected from the group consisting of Nd³⁺, Yb³⁺, Er³⁺, Tm³⁺, Pr³⁺, Tb³⁺, Ho³⁺, Dy³⁺, and Sm³⁺. The amount/concentration of the Ln³⁺ ion doped in the SrₓCa₁₋ₓZnOSe may be about 0.2 mol % to about 1 mol %. For example, in an embodiment where Ln³⁺ is Nd³⁺, the SrₓCa₁₋ₓZnOSe may be doped with about 0.2 mol % to about 1 mol % of the Nd³⁺.

As some specific embodiments, the host and the dopant may have a formula of Sr_{0.6}Ca_{0.4}ZnOSe:Ln³⁺, particularly Sr_{0.6}Ca_{0.4}ZnOSe:Nd³⁺. In these embodiments, the Sr_{0.6}Ca_{0.4}ZnOSe:Ln³⁺ may generate photoluminescence at about 480 nm to about 1540 nm in response to radiation stimuli at about 350 nm to about 360 nm. In addition, the luminescent material including the Sr_{0.6}Ca_{0.4}ZnOSe:Ln³⁺ as described herein may generate mechanoluminescence at about 480 nm to about 1540 nm in response to applied mechanical force of about 5 N to about 55 N. In particular, the intensity of the mechanoluminescence may be positively proportional to the applied mechanical force.

Without wishing to be bound by theory, it is believed that the availability of the mechanoluminescence from the Sr_{0.6}Ca_{0.4}ZnOSe:Ln³⁺ as described herein may be suitable for integrated information transmission systems. For example, as illustrated in the later part of the present disclosure, the Sr_{0.6}Ca_{0.4}ZnOSe:Ln³⁺ may be encapsulated by a transparent material selected from the group consisting of PET, PDMS, DBP, and a combination thereof, forming a thin film of, e.g., about 1 mm, and may be applied to a desired location for generate mechanoluminescence. In some embodiments, it is devised that the mechanoluminescence may be detectable through a biological tissue, such as an animal tissue mimicking human oral tissue, with a thickness of about 2 mm to about 8 mm. In some other embodiments, the thin film may be applied to an oral cavity model to simulate the biological environment. For example, the thin film may be applied to and/or integrated with a mouthguard, such as a mouthguard comprising ethylene vinyl acetate (EVA) polymer to generate NIR emission in response to biting action. In particular, given that the intensity of the mechanoluminescence of the Sr_{0.6}Ca_{0.4}ZnOSe:Ln³⁺ as described herein is positively proportional to the applied mechanical force, without wishing to be bound by theory, it is believed that transmission of complex information may be achieved by biting into prescribed patterns, thereby generating a sequence of emission pules that may be recorded and interpreted as, for example, Morse codes. Details of this application will be discussed in the later part of the present disclosure.

Hereinafter, the present invention is described more specifically by way of examples, but the present invention is not limited thereto.

### EXAMPLES

### Reagents

CaCO₃ and SrCO₃ (99.9%, Sigma-Aldrich), ZnSe (99.99%, Sigma-Aldrich), ZnS (99.99%, Sinopharm Group Co. Ltd.), Nd₂O₃, Yb₂O₃, Er₂O₃, Tm₂O₃, Pr₂O₃, Tb₂O₃, Ho₂O₃, Dy₂O₃, and Sm₂O₃ (99.99%, Alfa Aesar), and LiNO₃ (99.99%, Macklin) were all purchased and used as received.

### Characterization

XRD patterns were recorded on a Bruker AXS D2 phaser with graphite monochromatized Cu Kα radiation (λ=1.5406 Å). SEM images were recorded on a Hitachi SU 8020 microscope. EDX element maps were obtained by a HOBIRA EMAX X-ray detector. High-resolution STEM images were recorded on a JEOL JEM-3200FA microscope. The FIB sectioning of craters was carried out on an FIB microscope (FEI Scios) using a 30 kV Ga+ ion beam.

The absorption spectra were acquired from a Hitachi UH-4150 spectrophotometer. Raman spectra were detected on a WITEC 300R Raman system under 532 nm laser excitation. XPS spectra were obtained by Scanning Auger XPS Model 5802 (PHI, USA). PL excitation and emission spectra and time decay curves were recorded with an Edinburgh FLS 1000 spectrofluorometer equipped with a red-sensitive photomultiplier (Hamamatsu R928P). The decay curves were fitted by a double exponential function of I=A₁e^{-t/τ}^{₁}+A₂e^{-t/τ}^{₂}+I₀, and the average lifetimes were calculated according to

$${τ}_{ave} = \frac{{A}_{1} {τ}_{1}^{2} + {A}_{2} {τ}_{2}^{2}}{{A}_{1} {τ}_{1} + {A}_{2} {τ}_{2}} ,$$

where I is the luminescence lifetimes were calculated according to intensity at time t, τ₁ and τ₂ are the lifetimes, A₁, A₂, and I₀ are constants. A microsecond pulsed xenon flash lamp μF900 (60 W) and an ozone-free xenon lamp (450 W) were utilized as an excitation source for the emission decay and the steady-state measurements, respectively.

For ML test, stresses were loaded with a universal testing machine (SH-500, Wenzhou Sundoo Instruments Co., Ltd). ML spectra were collected by a Maya 2000 Pro spectrometer (Ocean Optics, 200-1100 nm) and a photonic multichannel analyzer C10028 spectrophotometer (Hamamatsu, 900-1700 nm), respectively. Photographs of the samples were taken with a digital camera (EOS 6D Mark II, Canon) and an NIR camera (InGaAs Goldeye G-030 TEC1, Allied Vision). TL curves were collected on a YULI instrument (TOSL-3DS) in the temperature range from 300 to 500 K at a heating rate of 1 °C/s after pre-excitation under 365 nm for 5 min. The sample temperature was controlled by an mK 2000 series high-precision temperature controller (Instec Inc., UK).

### Mechanoluminescence (ML) Measurement

In order to evaluate the ML performance, two transparent PET sheets (3.5×3.5 cm) were employed to encapsulate the uniform mixture of Sr_{0.6}Ca_{0.4}ZnOSe:Nd³⁺ or CaZnOS:Nd³⁺ samples (0.2 g) and PDMS (0.05 g).

### Theoretical Modelling

The Sr_{0.6}Ca_{0.4}ZnOSe crystal structure refinements were analyzed using the GASA. The simulated band structure and DOS of Sr_{0.6}Ca_{0.4}ZnOSe crystals were calculated by the HSE hybrid function using the VASPKIT code. The GGA-PBE functional was selected for the exchange and correlation potential. The cut-off energy for the plane-wave is 550 eV. The k-mesh of 10×10×3 in the Brillouin zone was chosen for integration. The total energies of the systems converge to 10-5 eV in the iteration solution of the Kohn-Sham equation. The force on each atom was reduced to 0.01 eV/Å after geometry optimization. The VESTA was used to plot crystal structures. The phonon dispersion spectra were calculated by the PHONOPY code.

### Cell Proliferation

The proliferation of the human esophageal squamous carcinoma cells (KYSE150) and human umbilical vein endothelial cells (HUVECs) on different concentrations of sample particles was evaluated using cell counting kit-8 assay.

### Preparation of the Mouthguard

Tooth models are prepared using a mixture of gypsum and water filled with a negative tooth mold and heated for drying. The mouthguards were obtained by covering the outside of the tooth mold with EVA copolymer and die casting at 100 °C for 20 min and then cooling down for use. To fabricate the mouthguard with NIR ML response, the Sr_{0.6}Ca_{0.4}ZnOSe:Nd³⁺ (0.05 g, [Nd^{3+]=0.4} mol %) samples were firstly mixed well with PDMS (0.02 g) and kept at a thickness of about 1 mm for drying. Next, the cooled film was attached to the tooth mold at different locations as required, and then the EVA copolymer was covered on the surface of the tooth mold in the same steps as described above. The cooled mouthguard was washed with ethanol and DI water for more than 3 times for the ML test.

### Example 1A

### Synthesis of Sr_{0.6}Ca_{0.4}ZnOSe

All the compounds were synthesized through a solid-state reaction method using CaCO₃, SrCO₃, and ZnSe as starting materials at high temperatures. Specifically, stoichiometric mixtures were first weighed according to the composition Sr_{0.6}Ca_{0.4}ZnOSe. The mixtures were transferred to a beaker and stirred for 10 min with 3 mL of ethanol. Grinding was then carried out in an agate mortar for 5 min followed by drying in an oven at 60 °C. The resulting dry mixtures were transferred to an Al₂O₃ crucible and calcined under N₂ atmosphere (99.5%; flow rate: 100 mL·min⁻¹) at temperatures ranging from 1000 to 1050 °C (heating rate: 5 °C·min⁻¹) for 3 h in a tube furnace. Finally, the samples were naturally cooled to room temperature and reground for further use and characterization. As a control, a certain percentage of flux (e.g., LiNO₃) was added during the weighing process and mixed with the raw materials.

### Example 1B

### Synthesis of CaZnOS and SrZnOS

CaZnOS and SrZnOS were synthesized using the same method described in Example 1A, except using CaCO₃ and ZnS or SrCO₃ and ZnS as the starting materials.

### Example 1C

### Synthesis of Lanthanide-doped Sr_{0.6}Ca_{0.4}ZnOSe

The synthetic procedures were the same as described in Example 1A expect that lanthanide oxide (e.g., Nd₂O₃, Yb₂O₃, Er₂O₃, Tm₂O₃, Pr₂O₃, Tb₂O₃, Ho₂O₃, Dy₂O₃, and Sm₂O₃) was introduced into the staring materials according to the stoichiometric ratios of Sr_{0.6-x}Ca_{0.4}ZnOSe:xLn³⁺, where x=0.2, 0.4, 0.6, 0.8, 1.0 mol %.

As a control, lanthanide doped CaZnOS was synthetized according to the procedures as described in Example 1B except that lanthanide oxide (e.g., Nd₂O₃, Yb₂O₃, Er₂O₃, Tm₂O₃, Pr₂O₃, and Tb₂O₃) was introduced into the staring materials according to Ca₁₋ₓZnOS:xLn³⁺, where x=0.2, 0.4, 0.6, 0.8, 1.0 mol %.

### Example 2

### Synthesis and Structural Characterization of SrZnOSe Crystals

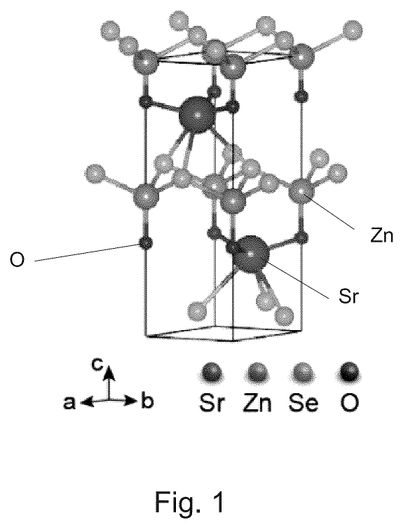

Theoretical simulations suggested that SrZnOSe is isostructural to CaZnOS with a space group of P6₃mc (FIG. 1). Accordingly, in the first attempt of the synthesis of SrZnOSe crystals, solid-state method that is reported for preparing CaZnOS was adopted. Specifically, alkaline-earth carbonate (AECO₃) and ZnSe were used as raw materials and calcined at 1000 °C for 3 h in an N₂ atmosphere. Ideally, it is expected that the synthesis will follow the reactions illustrated below:

AECO₃→AEO+CO₂⬆ (1)

AEO+ZnSe→AEZnOSe (2)

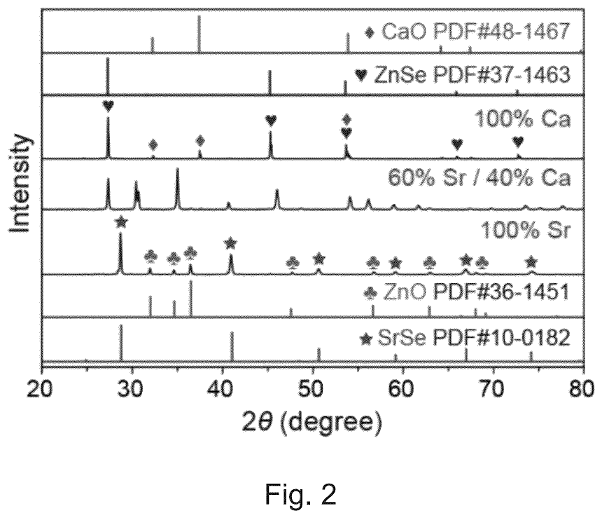

However, as shown in FIG. 2, only SrSe and ZnO were obtained when SrCO₃ was the sole alkaline-earth source, which is likely due to a displacement reaction between ZnSe and intermediate SrO.

Without wishing to be bound by theory, it is believed that CaO was more resistant to displacement reaction with ZnSe than SrO, and therefore the above reaction process may be tuned through Ca alloying. It is believed by introducing Ca into the precursor could result in a Sr(Ca)O intermediate phase with reduced displacement reactivity toward ZnSe. Consequently, the reaction would dominantly proceed according to Equation (2), yielding the target product of AEZnOSe.

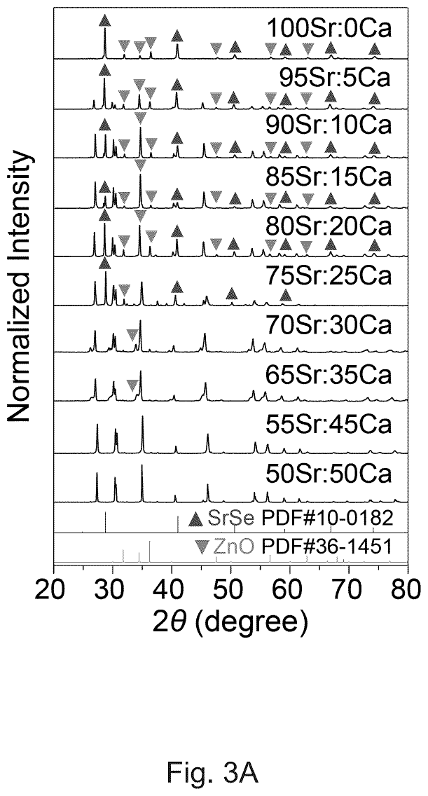

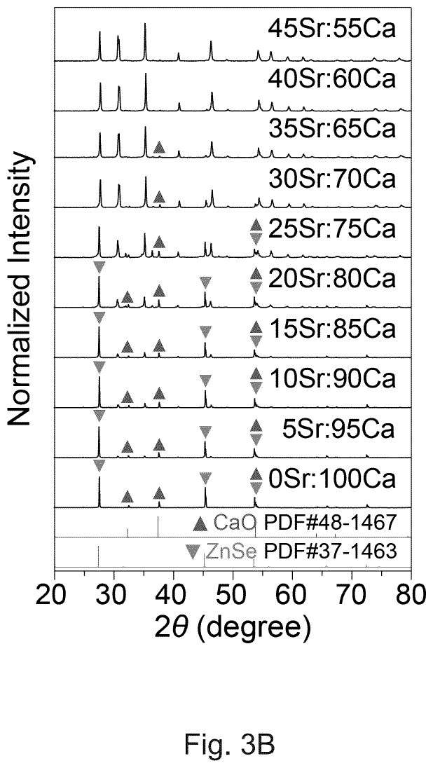

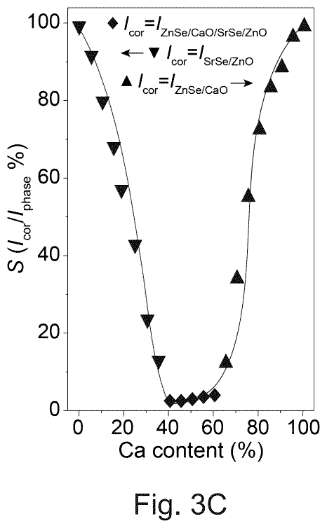

Based on the above, in a second attempt of the synthesis, binary mixtures of SrCO₃ and CaCO₃ at different mole ratios as the alkaline-earth source were used. X-ray powder diffraction (XRD) measurements showed a gradual reduction of SrSe and ZnO peaks with increasing Ca contents (FIG. 3A). In particular, the diffraction peaks related to the SrSe and ZnO phases completely disappeared at a Sr/Ca (mole) ratio of 60:40 (FIG. 2). Notably, as the Ca content continued to increase, the integral intensities of the impurity peaks corresponding to ZnSe and CaO gradually ascended, which may be ascribed to the low reactivity CaO (FIG. 3B). Accordingly, the relationship between the Ca/Sr ratio and the impurity phase of the resulting product may be summarized as shown in FIG. 3C using the following formula:

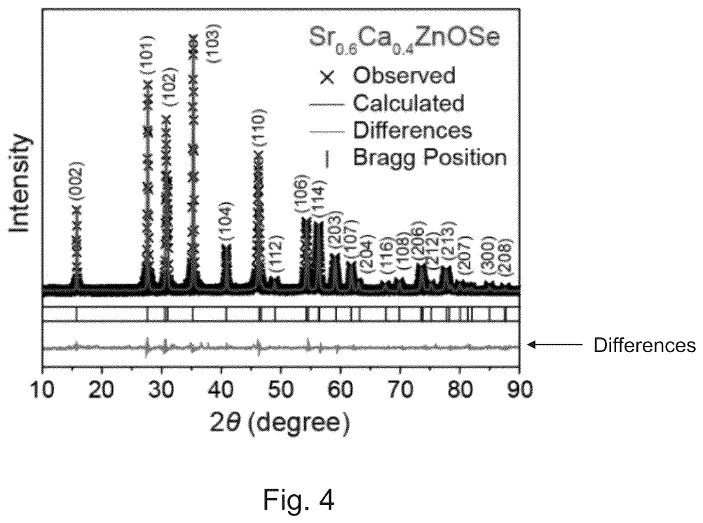

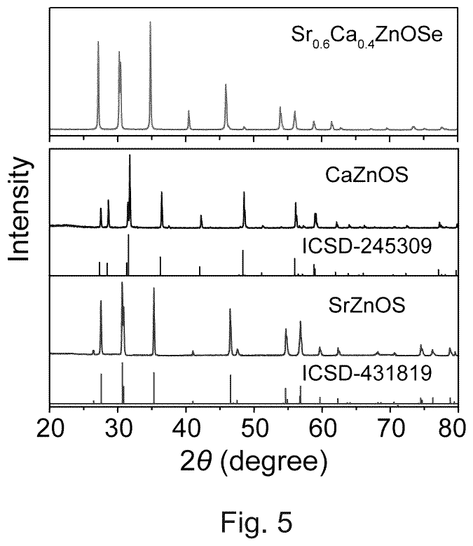

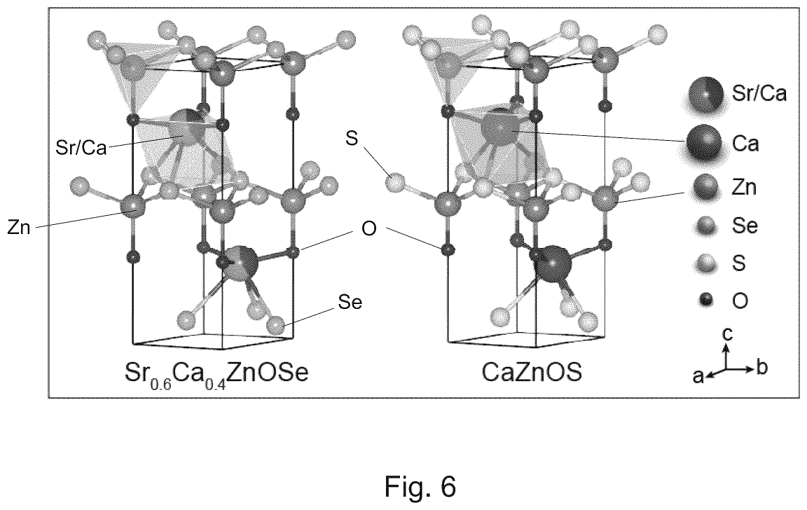

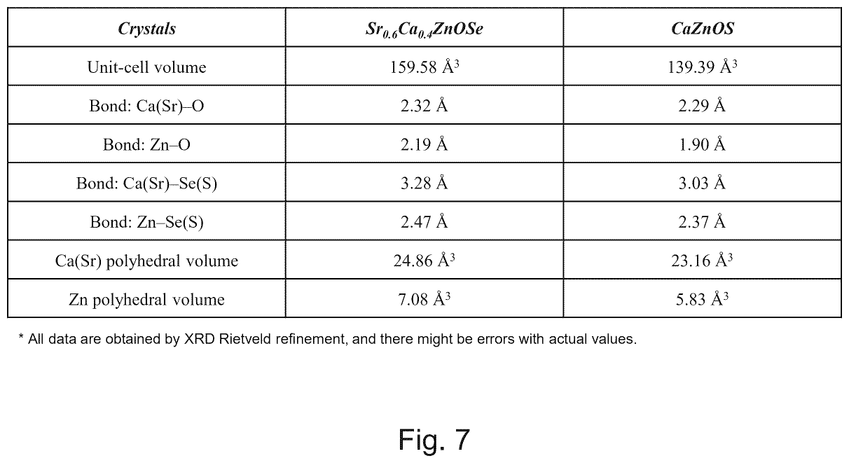

S=RIR*I_{cor}/Iₚₕₐₛₑ (3)
where S is the physical phase scale factor, RIR is the reference intensity ratio, I_{cor} is the integral intensity of diffraction peaks related to impurity phases in the sample, and Iₚₕₐₛₑ is the integral intensity of the pure phase peaks. The results reveal that pure-phase Sr/CaZnOSe can form at Sr/Ca (mole) ratios between 60:40 and 40:60. FIG. 4 shows Rietveld refinement of the XRD pattern of a representative product comprising 40 mol % of Ca, confirming the formation of single-phase Sr_{0.6}Ca_{0.4}ZnOSe with lattice parameters of a=b≈3.992 Å, and c≈11.932 Å. Comparative XRD investigations confirm that the Sr_{0.6}Ca_{0.4}ZnOSe crystal is isostructural to its sulfide counterparts (FIG. 5). The coordination environments of Sr²⁺ (Ca²⁺) and Zn²⁺ in Sr_{0.6}Ca_{0.4}ZnOSe were the same as those in the CaZnOS structure (FIG. 6). Due to the larger ionic radii, the bond lengths of Ca(Sr)—Se and Zn—Se in Sr_{0.6}Ca_{0.4}ZnOSe crystal are slightly longer than those of Ca—S and Zn—S in CaZnOS, resulting in larger [Sr(Ca)Se₃O₃] and [ZnSe₃O] polyhedrons (FIG. 7).

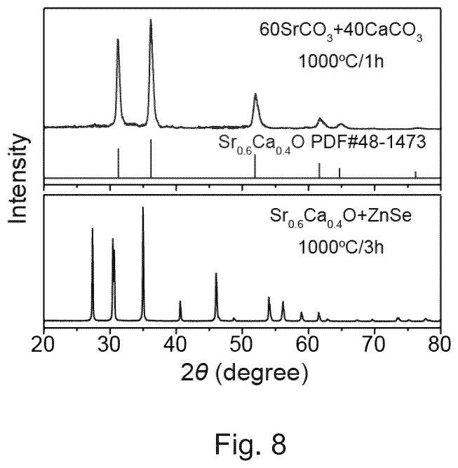

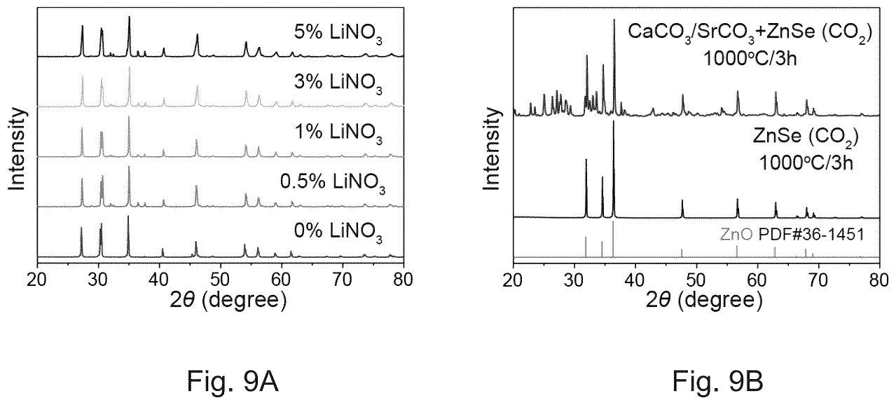

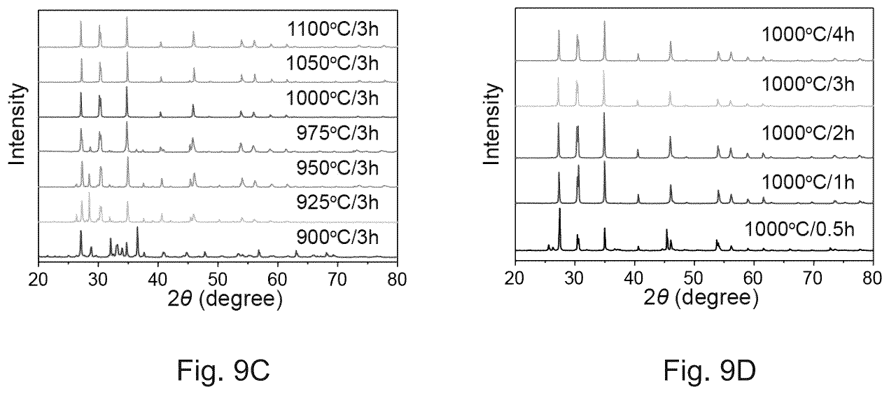

Control experiment confirmed that co-thermolysis of SrCO₃ and CaCO₃ at 1000 °C for 1 h formed a Sr(Ca)O solid solution, which was completely converted into Sr(Ca)ZnOSe after subsequent reaction with ZnSe at 1000 °C for 3 h (FIG. 8), in line with the proposed reaction mechanism. It is worth noting that the synthesis of this work is susceptible to flux. In particular, when LiNO₃ was added to the raw materials as a fluxing agent, XRD detected impurity phases such as Ca/SrSe and ZnO (FIG. 9A), probably due to the promotion of displacement reactions.

It is believed that the reaction conditions are also critical for the synthesis. In the ambient atmosphere, ZnSe tends to oxidize to ZnO due to the presence of CO₂, preventing the formation of selenides (FIG. 9B). Besides, employing an insufficient calcination temperature (e.g. ≤975 °C) or an insufficient reaction time (≤0.5 h at 1000 °C) could result in impurity phases due to incomplete reactions (FIGS. 9C and 9D). Notably, although an insufficient calcination temperature may not be remedied by prolonging the calcination time, insufficient calcination duration may be mitigated by an increase in the calcination temperature, e.g. by 100 °C. However, it is noted that a substantially high calcination temperature (>1400 °C) was found to be unfavorable, as it induces softening of the product, making sample collection difficult upon cooling.

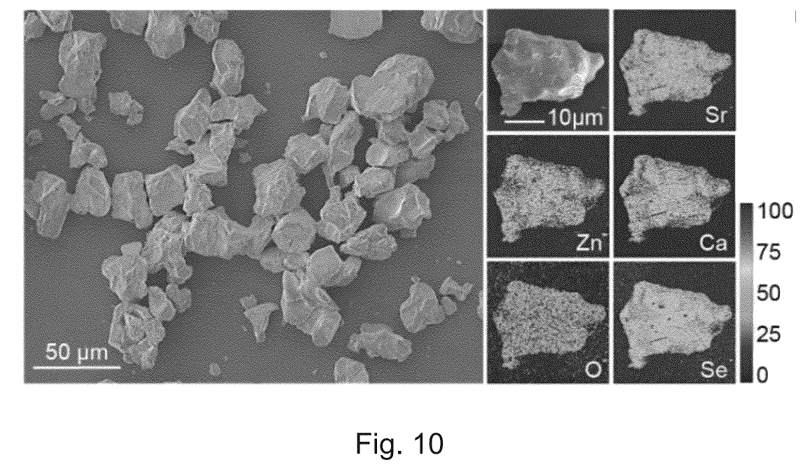

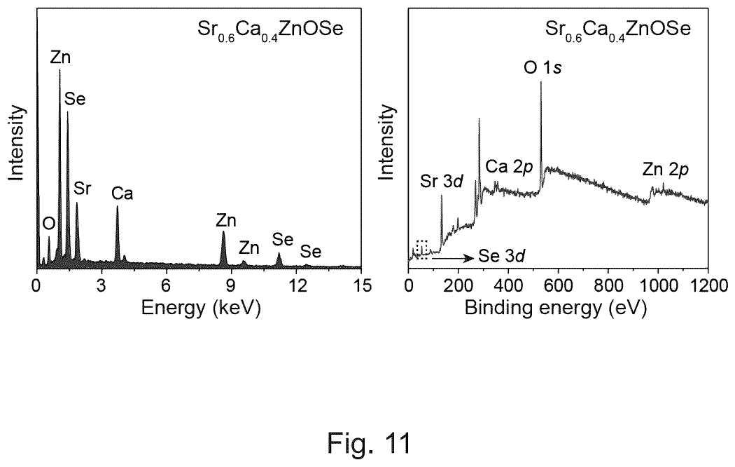

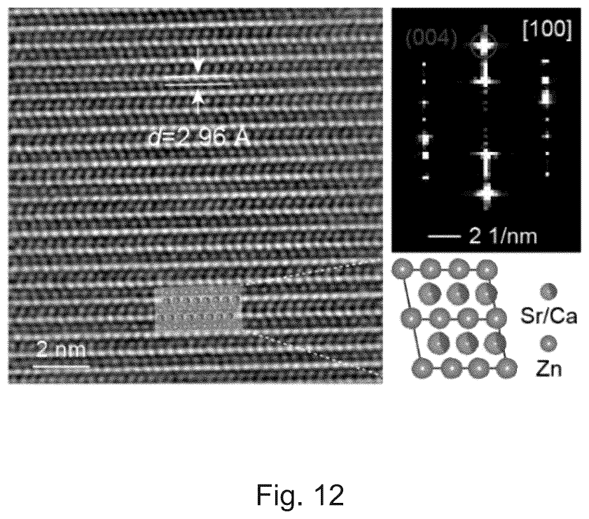

The as-prepared Sr_{0.6}Ca_{0.4}ZnOSe crystals were characterized by scanning electron microscopy (SEM). The result in FIG. 10 shows an irregular shape and rough surface of the sample with an average particle size of ≈25 μm. Compositional analyses reveal the presence of the constituent ions (i.e., Sr²⁺, Ca²⁺, Zn²⁺, O²⁻, and Se²⁻) across a single particle (FIGS. 10 and 11). The sample was further characterized by high-resolution scanning transmission electron microscopy (STEM) to provide more details on its crystal structure. The samples were prepared using the focused ion beam (FIB) technique. As depicted in FIG. 12, the STEM image and the associated fast Fourier transform diffractogram demonstrate the remarkable crystalline structure of the Sr_{0.6}Ca_{0.4}ZnOSe crystals.

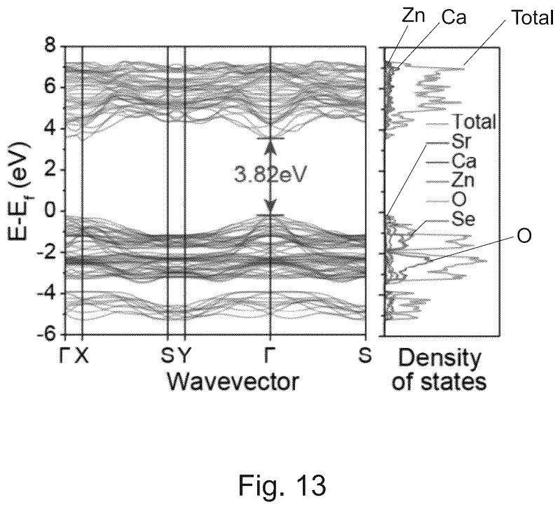

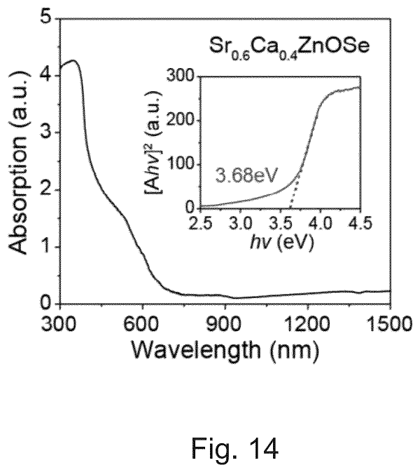

Based on first-principles calculations, it is determined that Sr_{0.6}Ca_{0.4}ZnOSe has a direct band structure with a bandgap of ≈3.82 eV (FIG. 13). The bandgap was also evaluated through the Tauc plot of the absorption spectrum (FIG. 14):

(ahv)²=A(hv−E_{g}) (4)
where a is the absorption coefficient, hv is the photon energy, A is the absorption constant, and E_{g} is the bandgap. The experimental bandgap value of ≈3.68 eV is in good agreement with the theoretical result and justifies the utility of the Sr_{0.6}Ca_{0.4}ZnOSe crystals for hosting lanthanide activators. Note that the absorption in the wavelength range of 350-650 nm, as shown in FIG. 14, could be attributed to inter-band transitions in the host, such as Vo²⁺ and V_{ZnO} formed during the synthesis.

### Example 3

### Photophysical Characterization of Lanthanide-doped Sr_{0.6}Ca_{0.4}ZnOSe (Sr_{0.6}Ca_{0.4}ZnOSe:Ln³⁺)

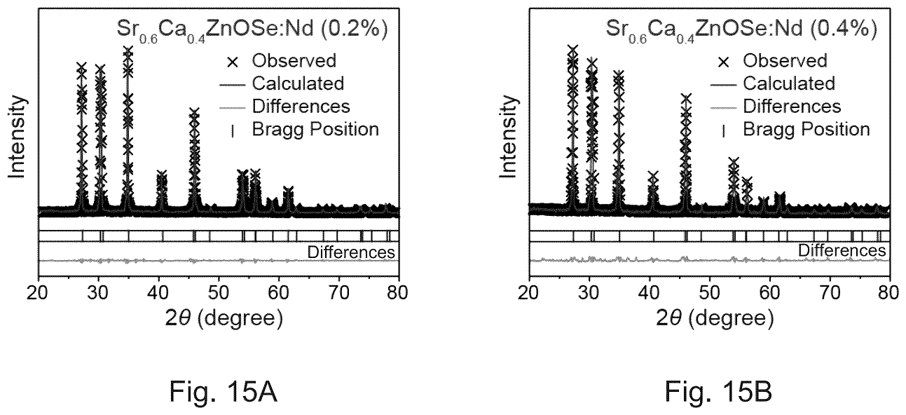

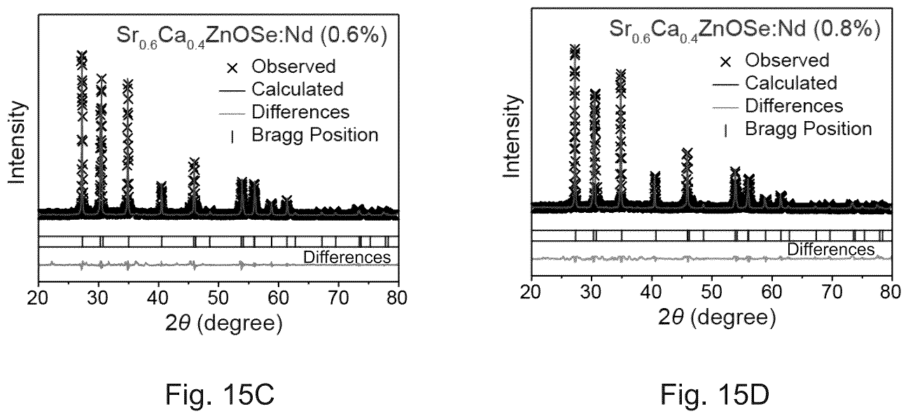

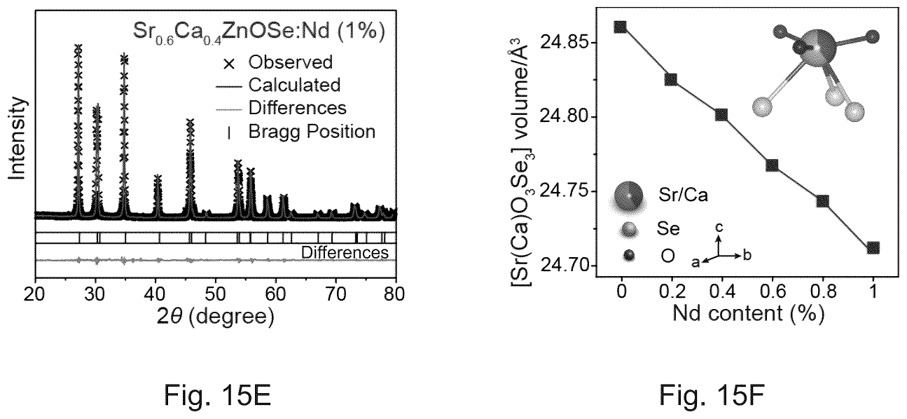

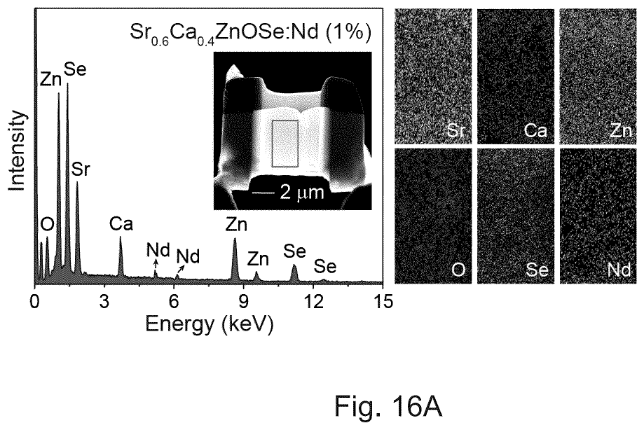

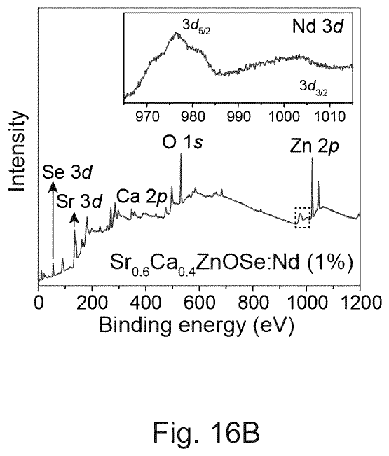

The performance of Sr_{0.6}Ca_{0.4}ZnOSe as a luminescent host was examined by using Nd³⁺ ions as a model dopant, which emits in the second NIR window (NIR-II, 1000-1700 nm). According to Rietveld refinement of the XRD patterns (FIGS. 15A to 15E), the samples maintained a consistent phase with Sr_{0.6}Ca_{0.4}ZnOSe crystals after doping 0.2-1 mol % of Nd³⁺, accompanied by a gradual decrease in the volume of the [Sr(Ca)O₃Se₃] polyhedron (FIG. 15F). These results demonstrated that Nd³⁺ ions (r=0.983 Å, CN=6) were successfully incorporated into the host lattice by substituting for larger Sr²⁺ (r=1.18 Å, CN=6) or Ca²⁺ (r=1.00 Å, CN=6) ions, which were further supported by compositional analyses through EDX and XPS (FIGS. 16A and 16B).

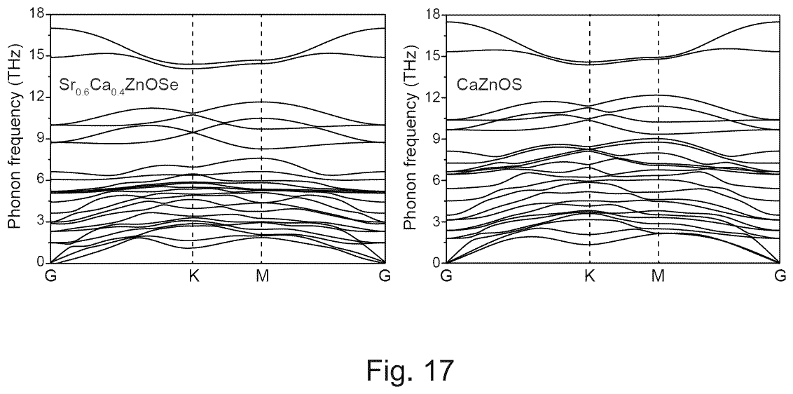

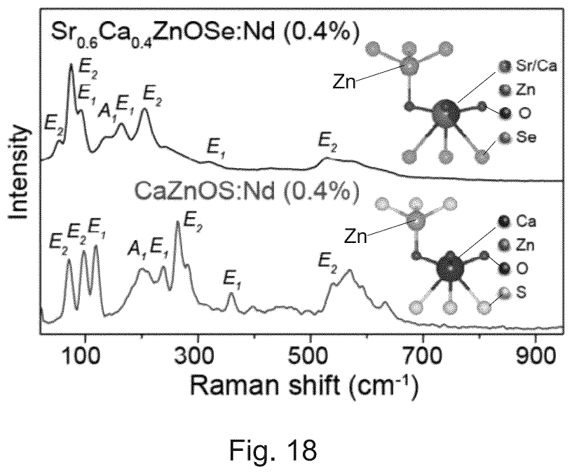

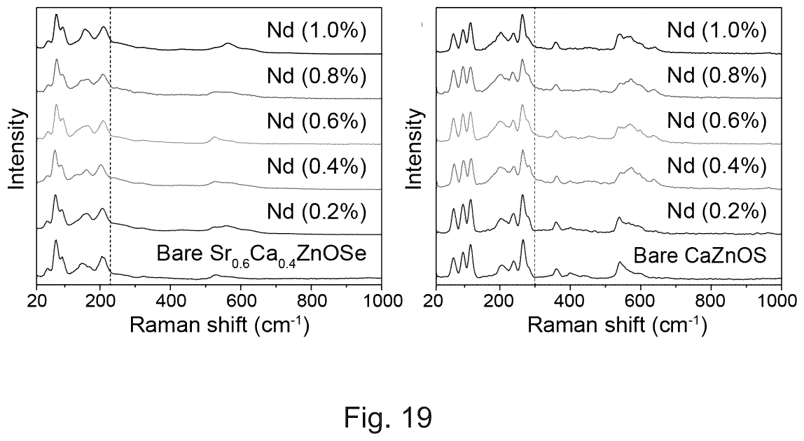

The phonon energies of the Sr_{0.6}Ca_{0.4}ZnOSe crystals were studied using Raman spectroscopy. In line with the calculation by density-functional theory (FIG. 17), the Raman spectrum of Sr_{0.6}Ca_{0.4}ZnOSe:Nd³⁺ closely resembled that of CaZnOS:Nd³⁺, comprising the double simplicial vibrational E mode (symmetric E mode and antisymmetric E₂ mode) and the singlet simplicial vibrational A₁ mode (FIG. 18). The observations stemmed from similar structures and coordination environments of the two crystals. However, due to the heavy atom effect, the Sr_{0.6}Ca_{0.4}ZnOSe crystal exhibited an appreciably smaller cut-off phonon energy (≈220 cm⁻¹) than CaZnOS (≈300 cm⁻¹), which was essentially unaffected by low concentrations (<1 mol %) of Nd³⁺ doping (FIG. 19). Therefore, it is believed that the Sr_{0.6}Ca_{0.4}ZnOSe crystals is more advantageous for hosting NIR-emitting lanthanide ions that are very sensitive to quenching by high-energy vibrations.

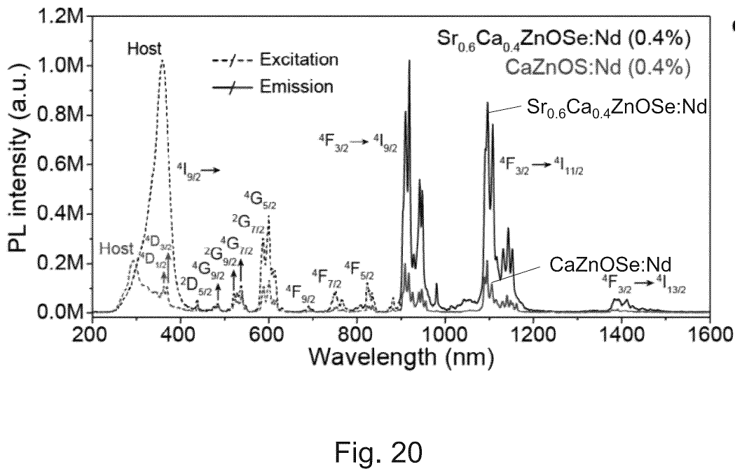

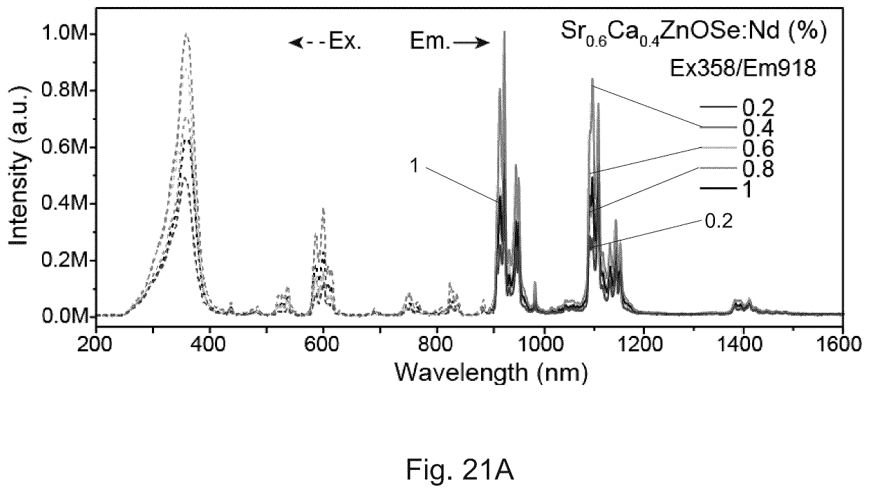

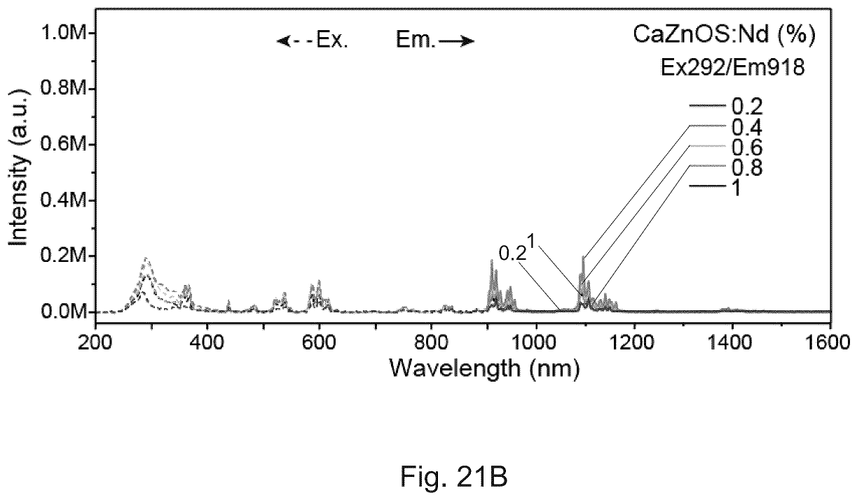

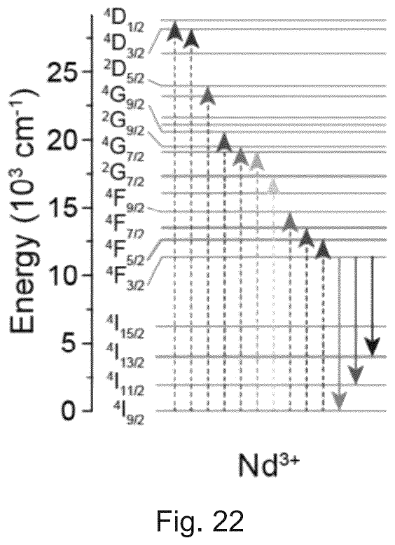

FIG. 20 presents the photoluminescence (PL) excitation and emission spectrum of Sr_{0.6}Ca_{0.4}ZnOSe:Nd³⁺ crystals at an optimal doping concentration of 0.4 mol % (refer to FIGS. 21A and 21B). Corresponding spectra of CaZnOS:Nd³⁺ (0.4 mol %) are also included for comparison. The results show that both samples exhibit host excitation bands and 4f transitions of Nd³⁺ in the PL excitation spectra (FIG. 22), demonstrating a host-sensitized luminescence process. The PL emission spectra of both samples exhibit characteristic Nd³⁺ emission bands at 918 and 1108 nm (FIGS. 20 and 22). As shown, the PL intensity of Sr_{0.6}Ca_{0.4}ZnOSe:Nd³⁺ was much higher (≈5 folds at 0.4 mol %) than that of CaZnOS:Nd³⁺ at different doping concentrations under the same test conditions (FIGS. 21A and 21B).

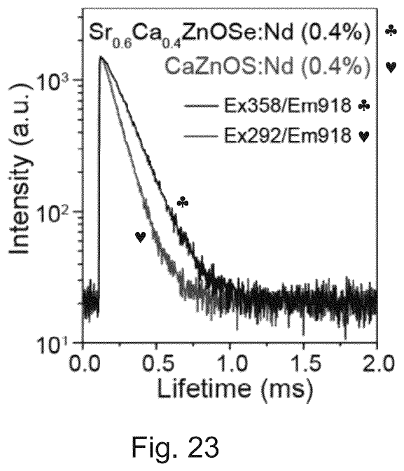

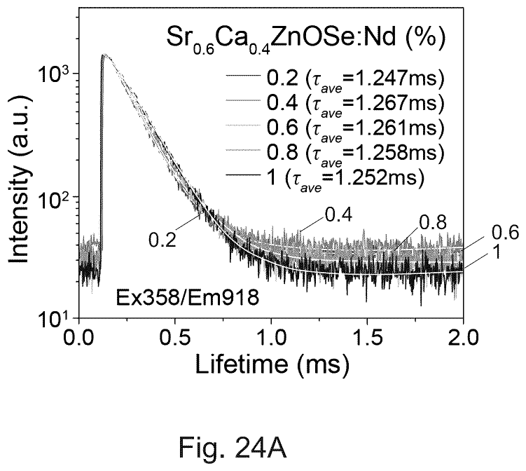

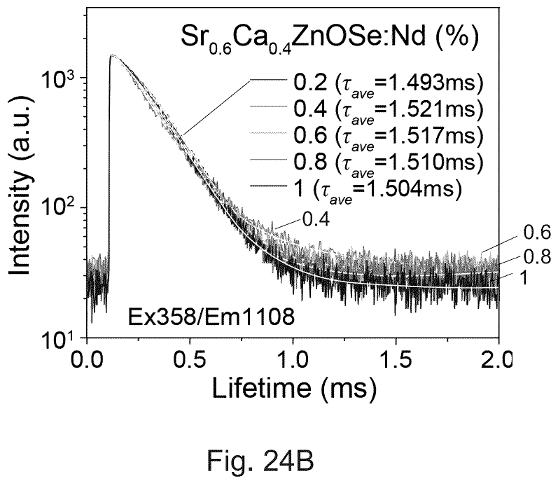

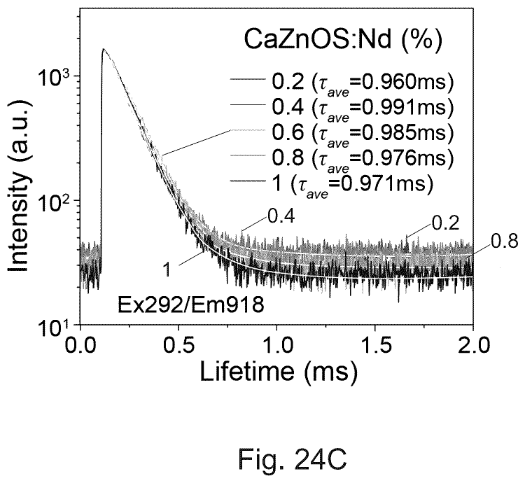

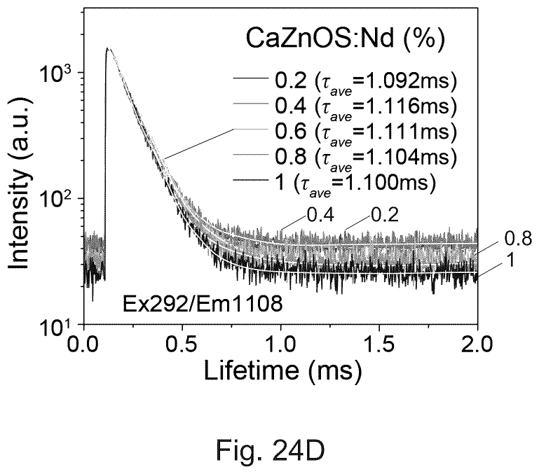

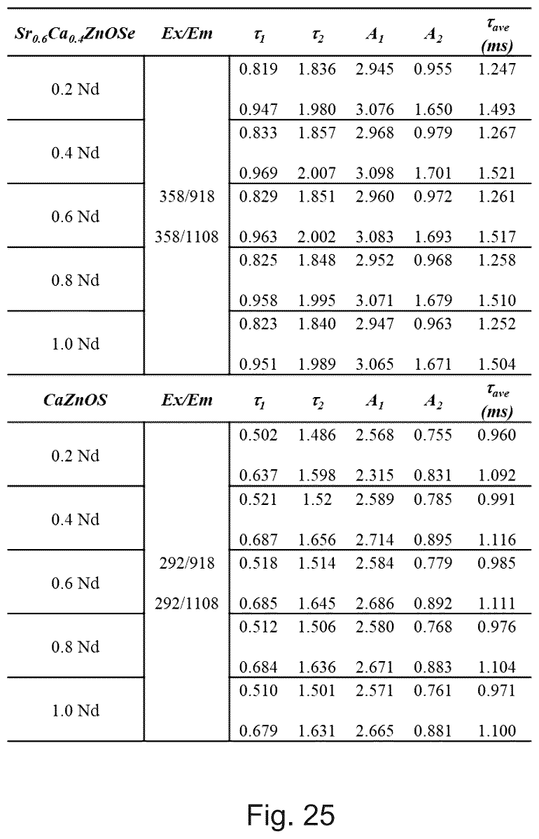

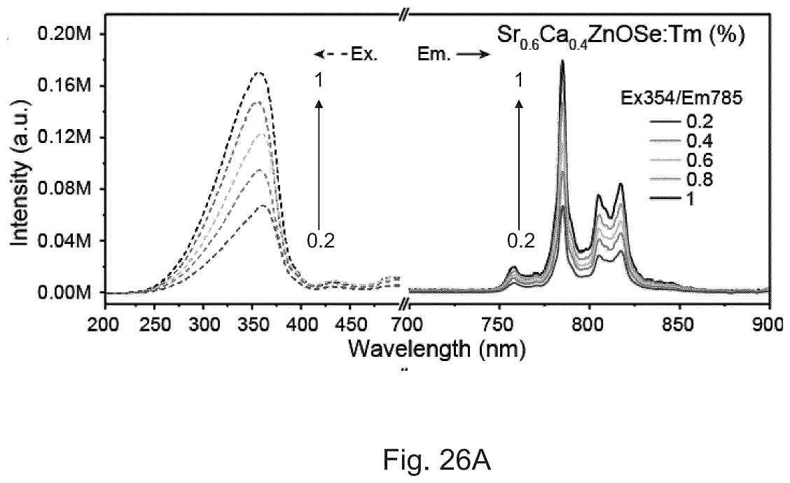

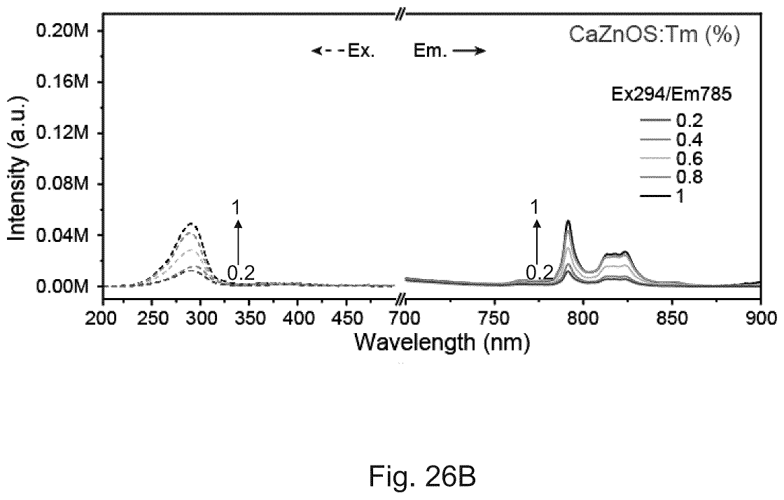

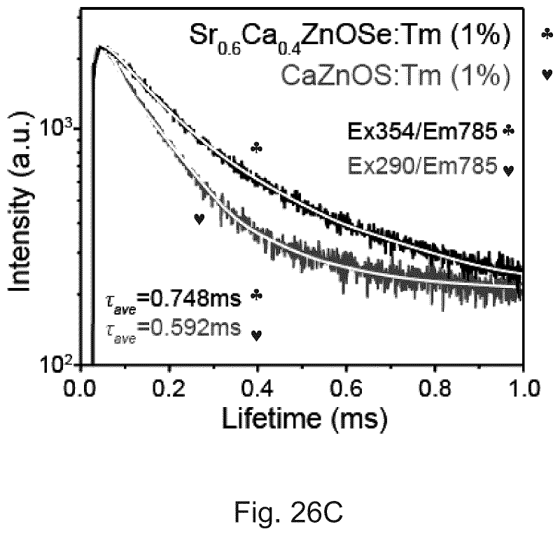

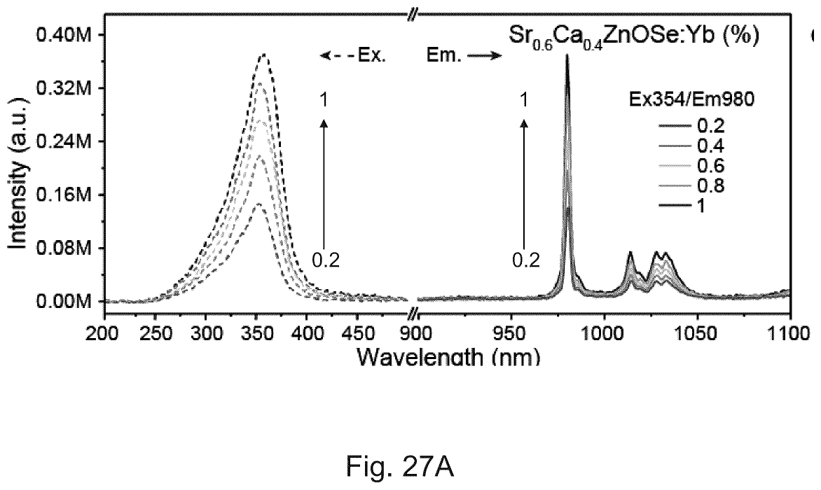

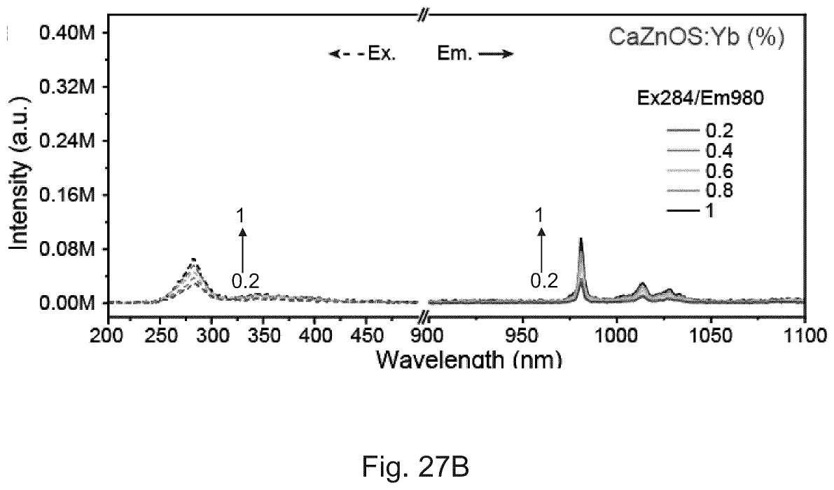

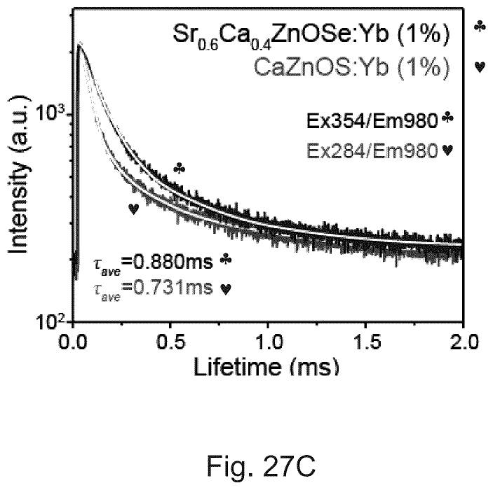

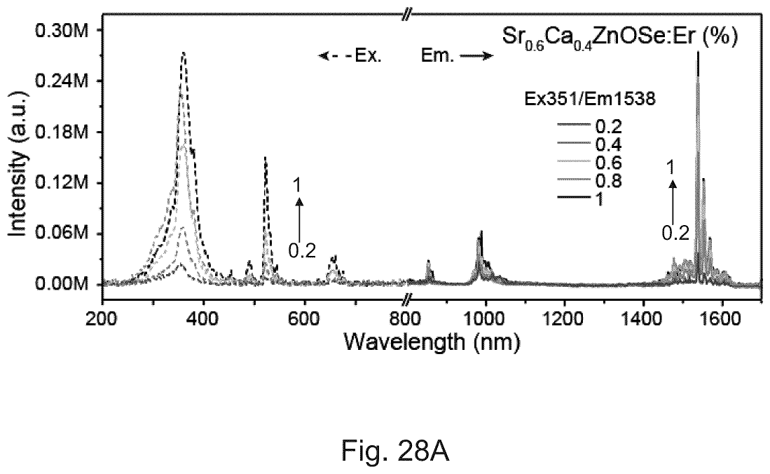

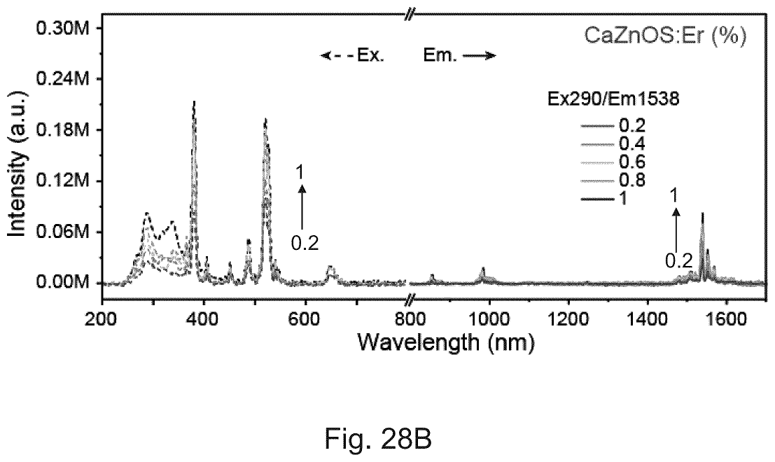

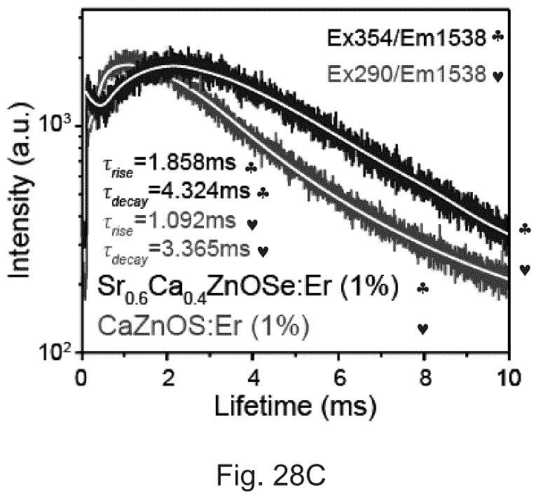

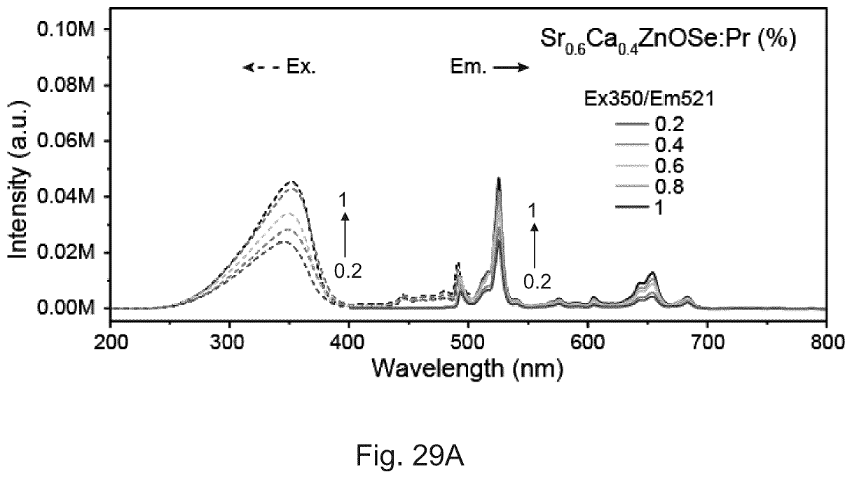

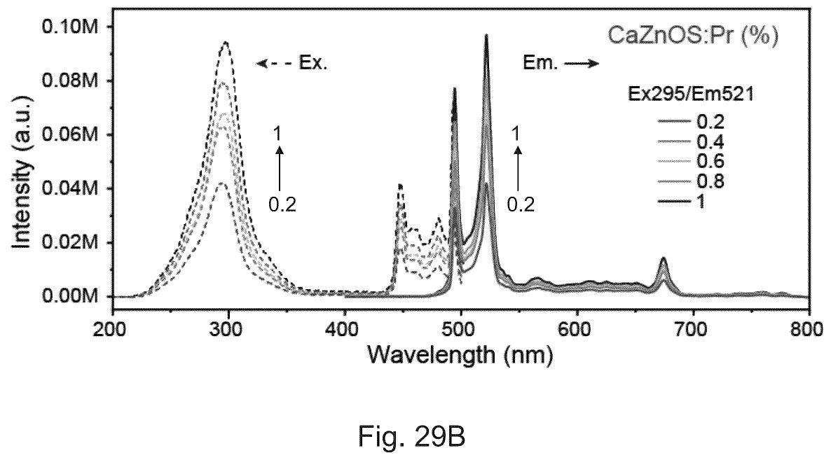

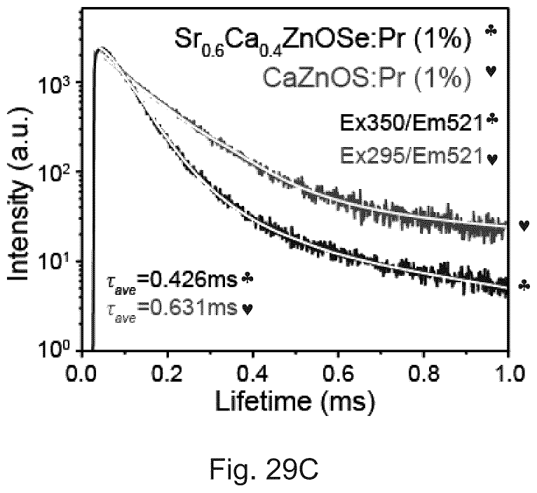

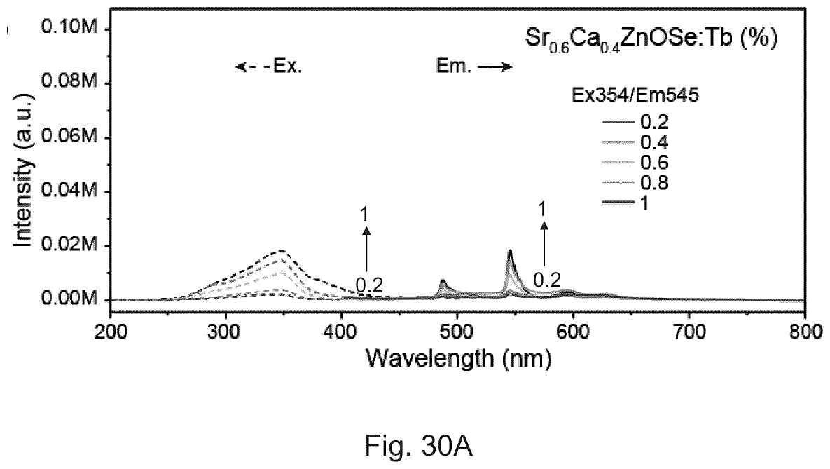

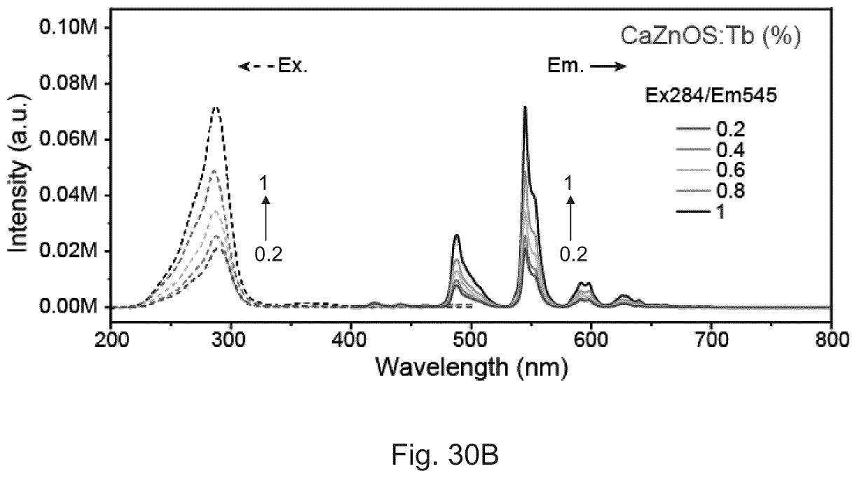

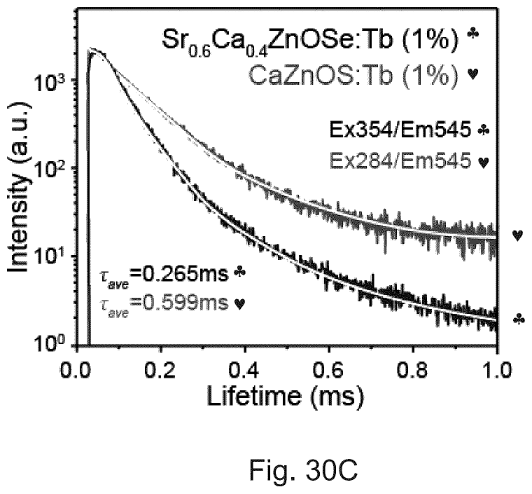

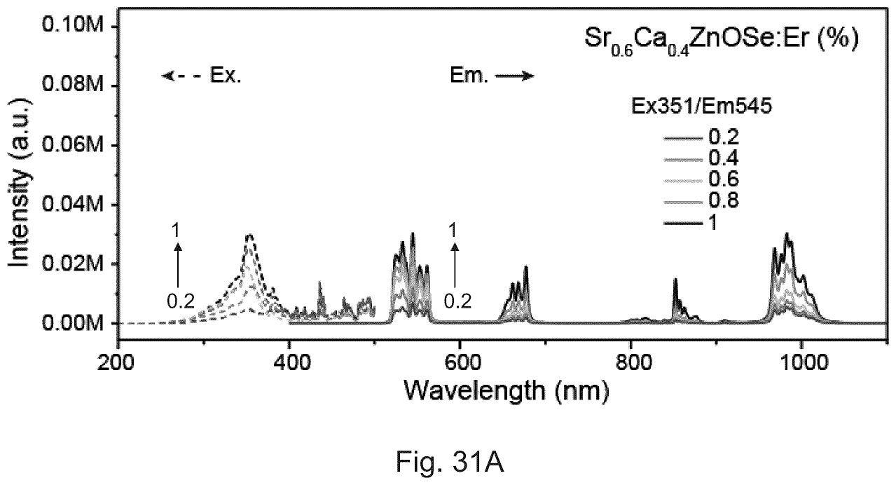

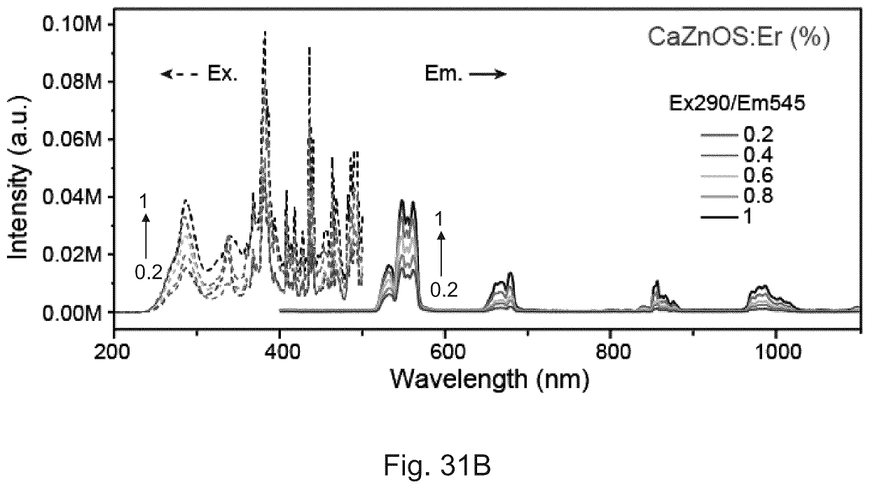

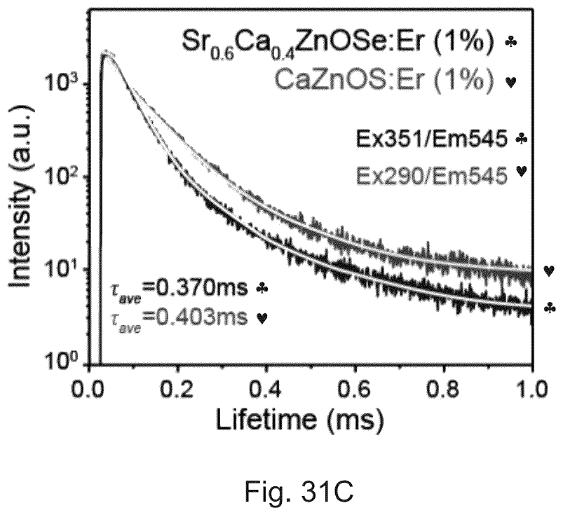

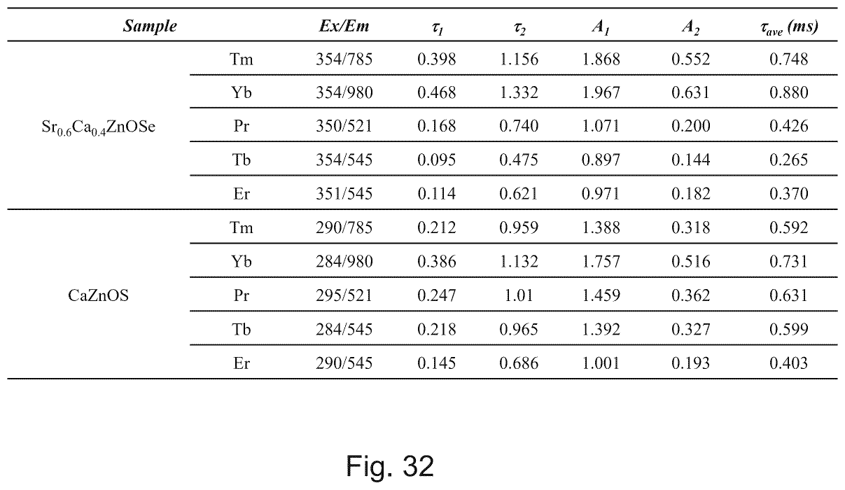

It is believed that the efficient Nd³⁺ emission in the Sr_{0.6}Ca_{0.4}ZnOSe host was attributed to the low phonon energies, which minimized the quenching of the excited state. Time decay measurements revealed a longer lifetime of Nd³⁺ in Sr_{0.6}Ca_{0.4}ZnOSe than CaZnOS, supporting that non-radiative relaxation of Nd³⁺ was suppressed in the low phonon energy environment (FIG. 23, FIGS. 24A to 24D, and FIG. 25) Similar emission enhancement and lifetime increase were observed for Tm³⁺ (785 nm), Yb³⁺ (980 nm), and Er³⁺ (1538 nm) dopants in Sr_{0.6}Ca_{0.4}ZnOSe crystals relative to CaZnOS (FIGS. 26A to 26C, FIGS. 27A to 27C, and FIGS. 28A to 28C). In contrast, Sr_{0.6}Ca_{0.4}ZnOSe showed similar photoluminescence properties to CaZnOS for visible emissions that are relatively resistant to multiphonon relaxation (FIGS. 29A to 29C, FIGS. 30A to 30C, FIGS. 31A to 31C, and FIG. 32). It is believed that these results validate the primary role of low phonon energy of the Sr_{0.6}Ca_{0.4}ZnOSe host in promoting the NIR luminescence.

### Example 4

### Mechanoluminescence Characterization of Lanthanide-doped Sr_{0.6}Ca_{0.4}ZnOSe (Sr_{0.6}Ca_{0.4}ZnOSe:Ln³⁺)

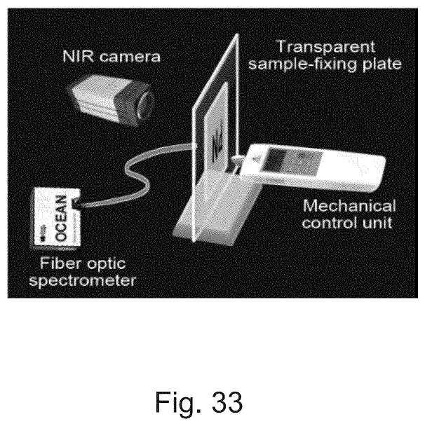

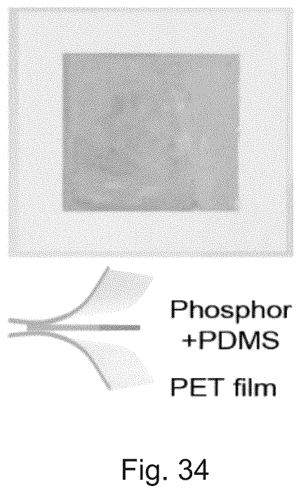

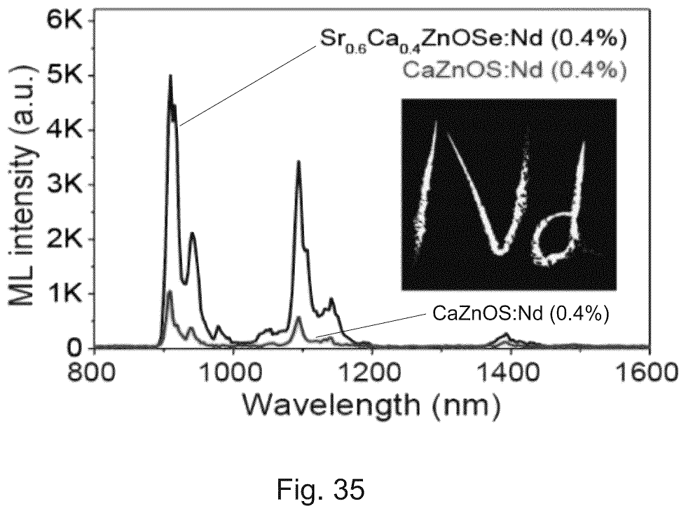

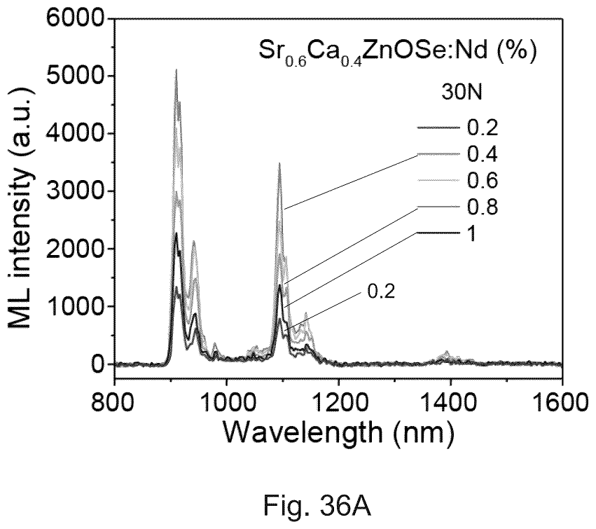

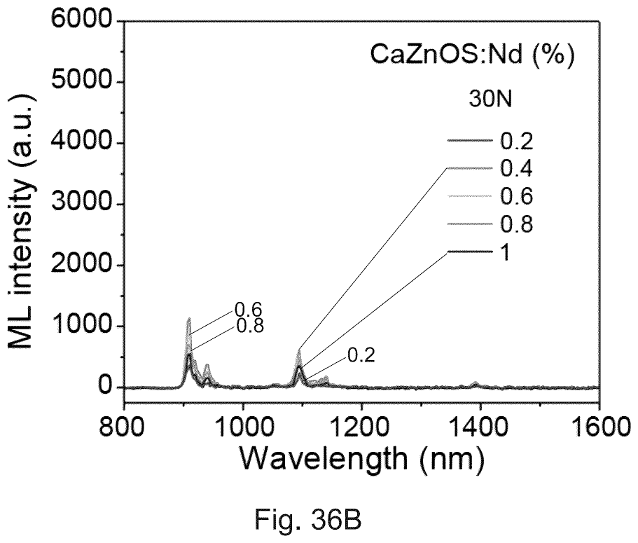

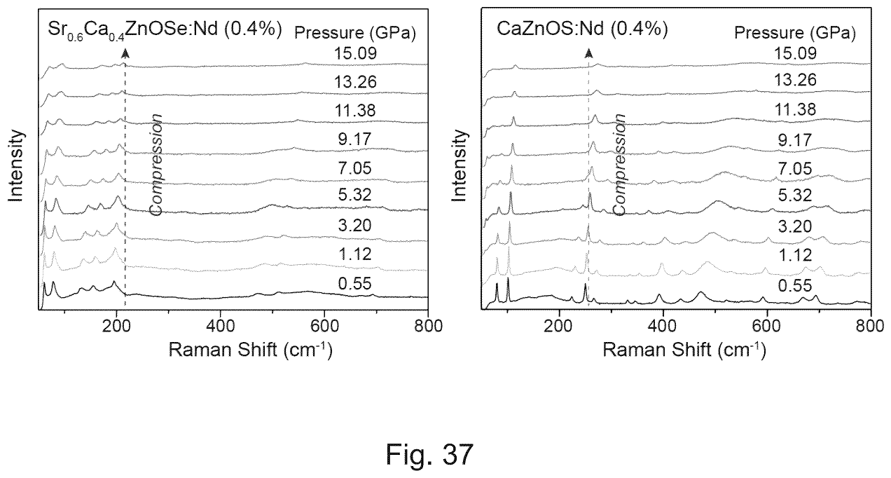

The ML properties of the Sr_{0.6}Ca_{0.4}ZnOSe:Nd³⁺ crystals were examined. An exemplary instrument was built to quantify the ML performance (FIG. 33). The ML sample was encapsulated within a transparent PET film for measurements (FIG. 34). FIG. 35 presents the ML spectrum of the Sr_{0.6}Ca_{0.4}ZnOSe:Nd³⁺ (0.4 mol %) under mechanical excitation at 30 N, which comprised characteristic Nd³⁺ transitions, in resemblance to the PL spectrum. Similar to the case of PL, the ML of Sr_{0.6}Ca_{0.4}ZnOSe:Nd³⁺ also showed a much higher (≈4.8 folds at 0.4 mol %) intensity than that of CaZnOS:Nd³⁺ over the doping concentration range from 0.2 mol % to 1.0 mol % (FIGS. 36A and 36B). It is believed that the superior ML performance in Sr_{0.6}Ca_{0.4}ZnOSe:Nd³⁺ was largely enabled by the consistently low phonon energy in the host lattice under pressure according to in-situ Raman spectroscopy (FIG. 37).

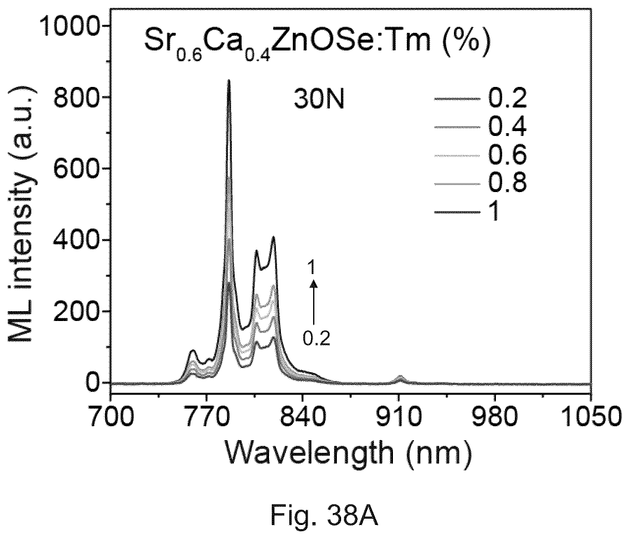

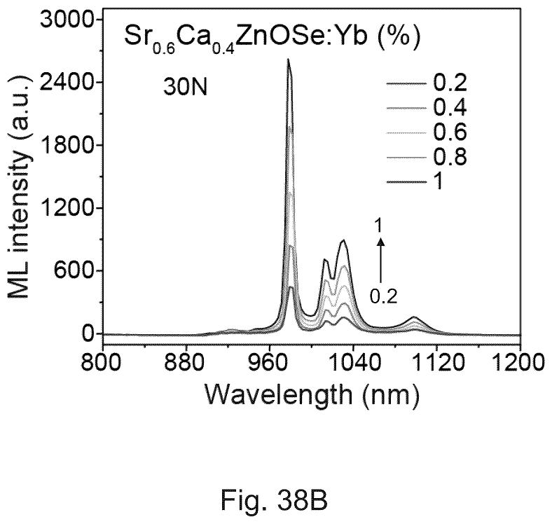

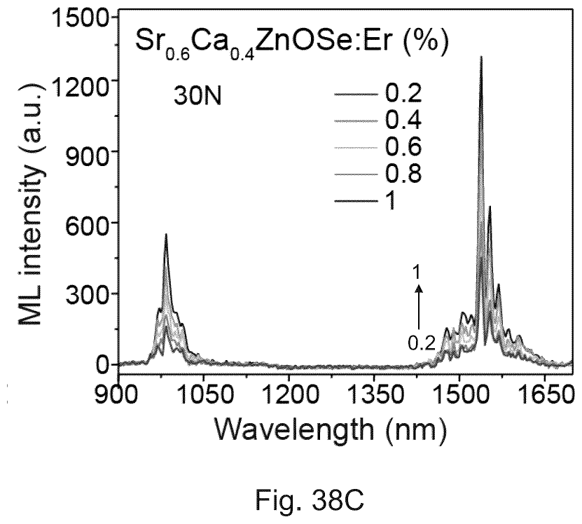

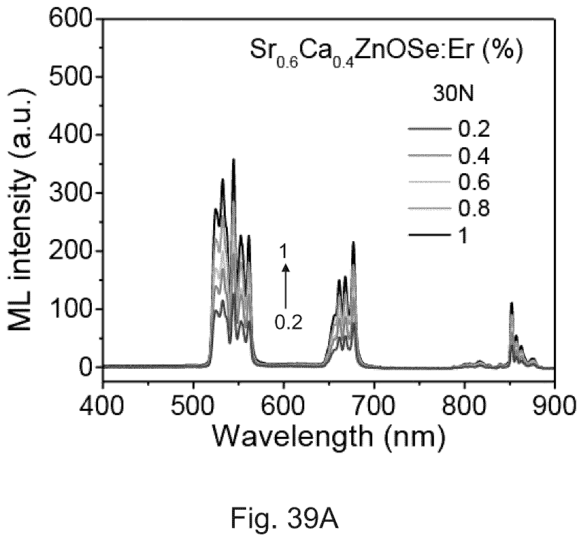

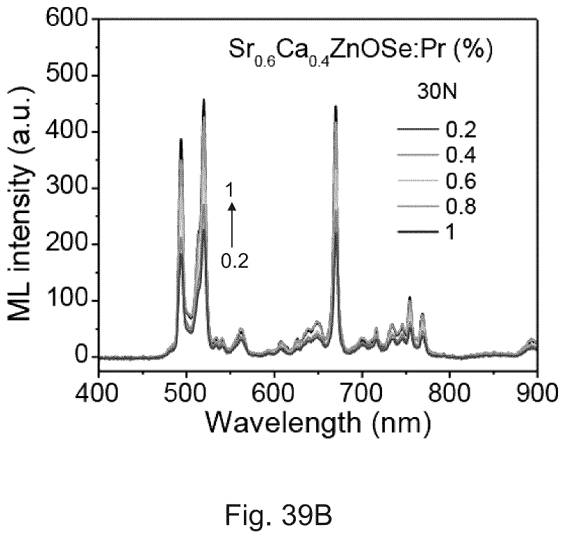

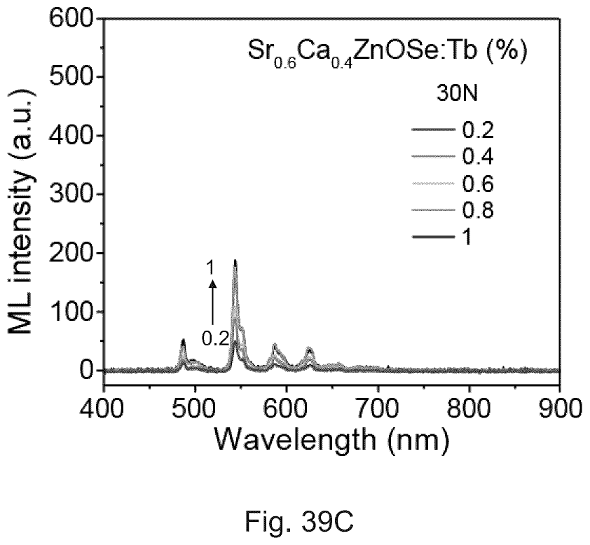

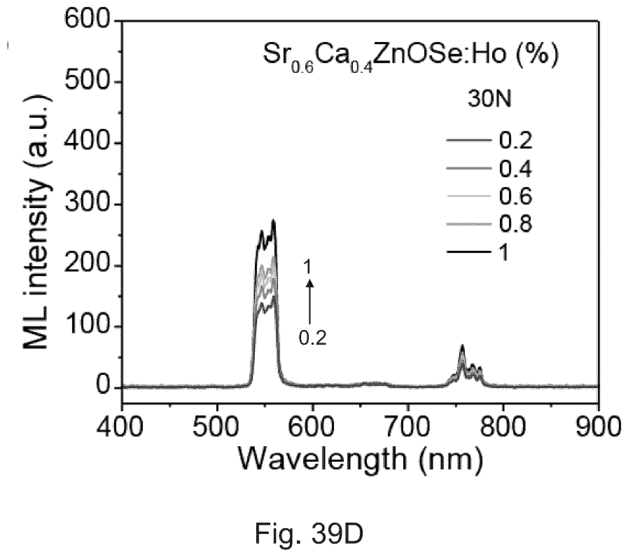

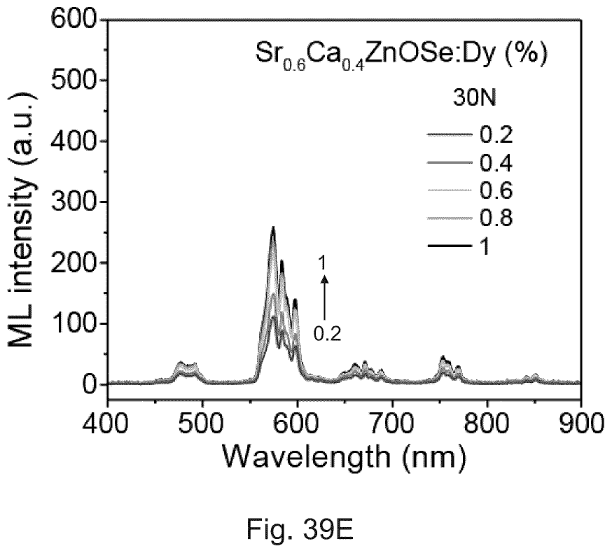

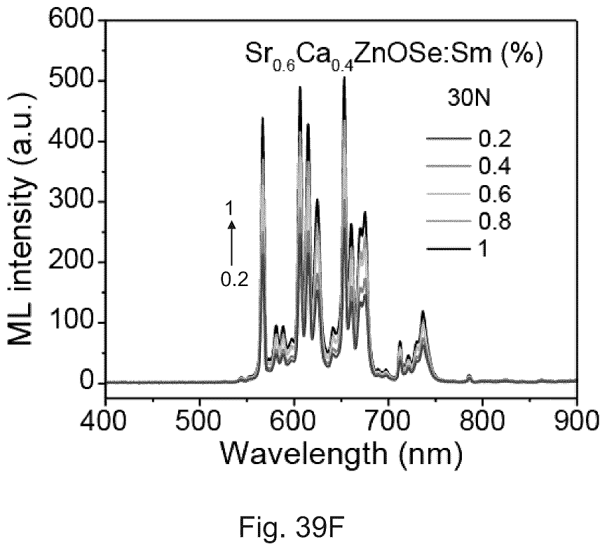

Owing to the bright emission, the force trajectory could be sensitively visualized through continuous exposure (FIG. 35, inset). It is worth noting that high-performance ML of Tm³⁺, Yb³⁺, Er³⁺, Pr³⁺, Tb³⁺, Ho³⁺, Dy³⁺, and Sm³⁺ were also obtained in the Sr_{0.6}Ca_{0.4}ZnOSe host, rendering tunable emissions spanning the visible and NIR spectrum (FIGS. 38A to 38C and FIGS. 39A to 39F).

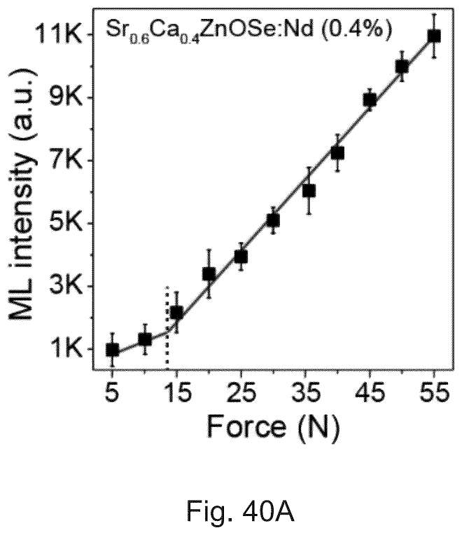

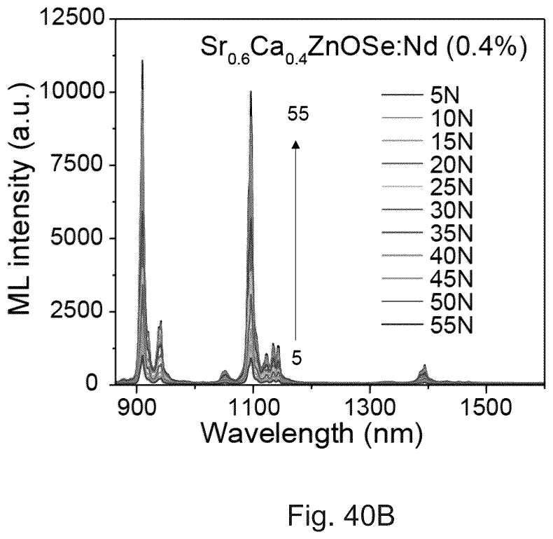

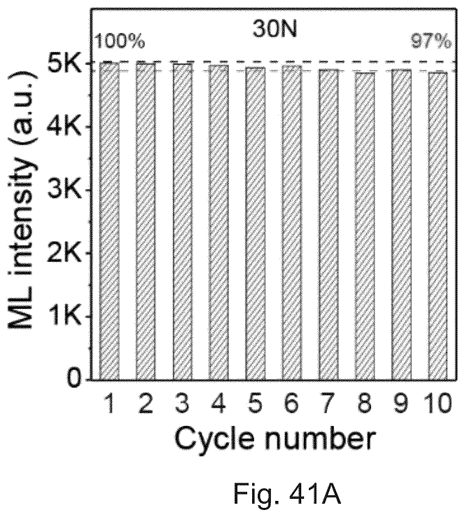

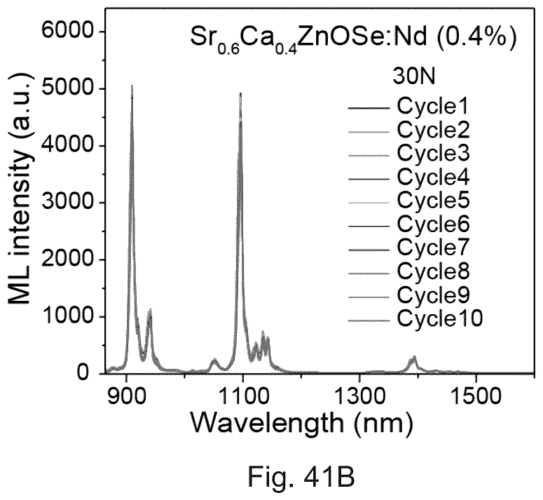

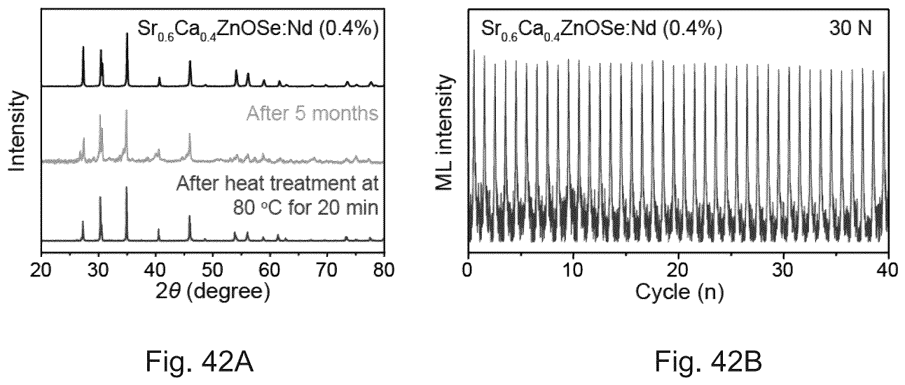

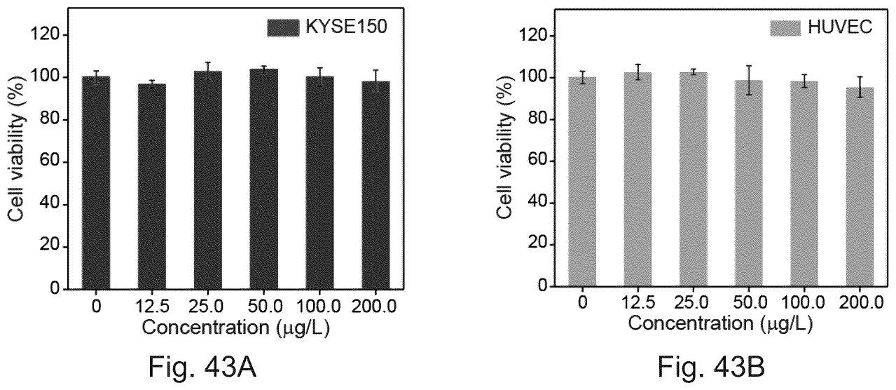

It is observed a linear dependence of ML intensity on the applied force for the Sr_{0.6}Ca_{0.4}ZnOSe:Nd³⁺ crystals (FIGS. 40A and 40B), demonstrating the potential of the lanthanide-doped SrCaZnOSe crystals for stress sensing applications. Specifically, two distinct regions could be identified in the intensity evolution curve, which is believed to be attributed to a variation of ML mechanism from the triboelectric effect to the piezoelectric effect as reported in other ML materials, such as CaZnOS, Ga₂O₃, and Sr₃Sn₂O₇. The Sr_{0.6}Ca_{0.4}ZnOSe:Nd³⁺ crystals also showed a highly repeatable ML performance. Repeatability tests on the composite PET film showed that the ML crystals maintained 97% of the initial intensity after 10 cycles of mechanical actions at 30 N (FIGS. 41A and 41B Notably, the integrity and ML performance of the sample can be essentially preserved after 5 months of storage at room temperature in ambient air (FIGS. 42A and 42B). Moreover, the cell proliferation assay showed that the sample induced no noticeable toxicity to human cells, demonstrating its good biocompatibility (FIGS. 43A and 43B).

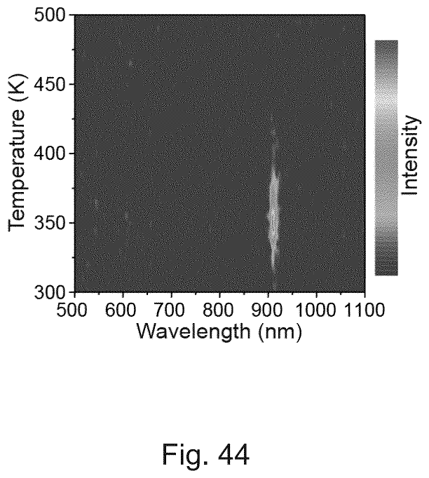

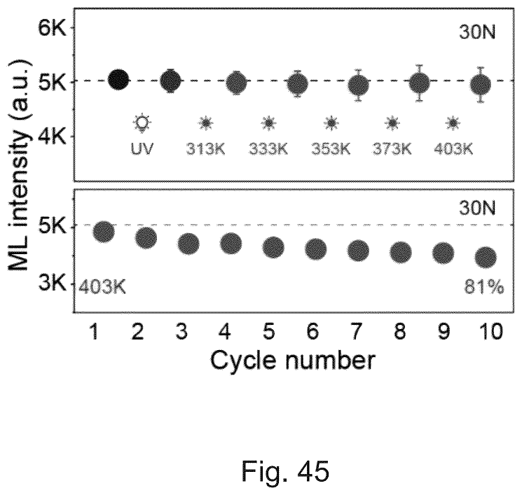

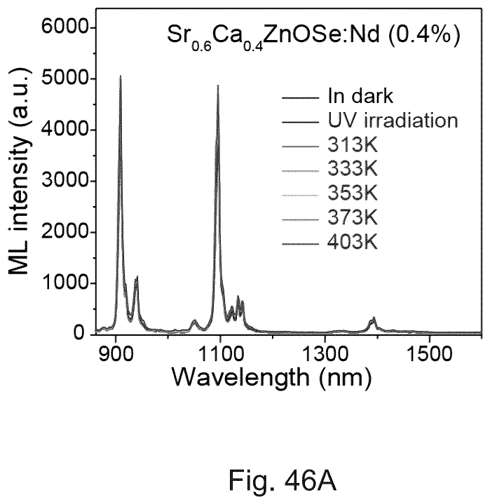

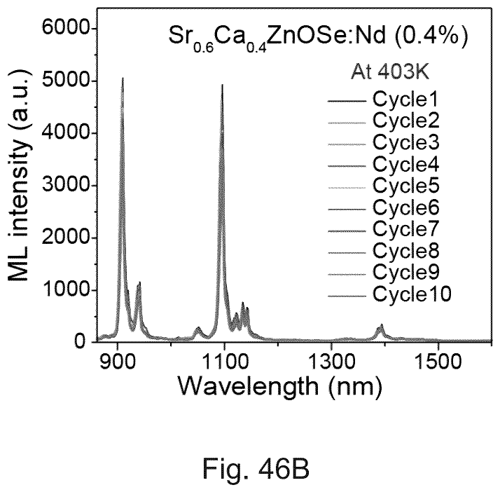

To further investigate the ML process, trap states in the crystals were assessed by thermoluminescence (TL) measurement. The TL spectra of the UV-charged sample exhibited a broad TL band in the temperature range of 300-500 K (FIG. 44), suggesting the existence of shallow traps in the crystals. However, the ML intensity of the sample was essentially unaffected by UV charging (365 nm, 5 min) and heat treatment (404 K, 5 min) (FIG. 45, top panel, and FIG. 46A), which are known to populate and empty traps, respectively. These results imply that the ML in these Sr_{0.6}Ca_{0.4}ZnOSe:Nd³⁺ crystals are not mediated by traps, and the luminescence process is directly activated by external mechanical action. Notably, the sample also maintained a good repeatability at high temperature (403 K). Only a slight loss of ML intensity was detected due to the softening of the PET film (FIG. 45, bottom panel, and FIG. 46B).

### Example 5

### Application of Lanthanide-doped Sr_{0.6}Ca_{0.4}ZnOSe (Sr_{0.6}Ca_{0.4}ZnOSe:Ln³⁺) in Integrated Information Transmission

It is believed that the availability of bright ML NIR emission from Sr_{0.6}Ca_{0.4}ZnOSe crystals offers significant opportunities for the development of integrated information transmission systems. As a proof-of-concept, it is demonstrated that the ML crystals may allow the generation and transmission of encrypted optical information in tissue environments.

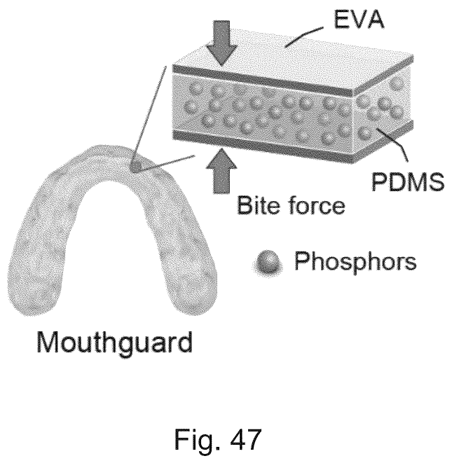

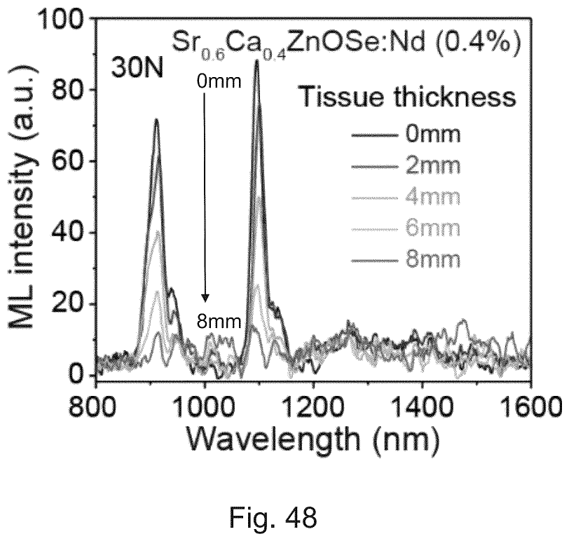

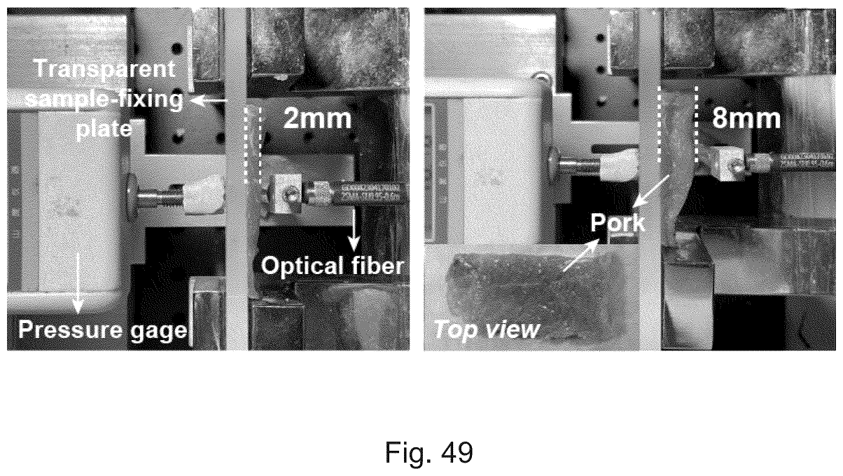

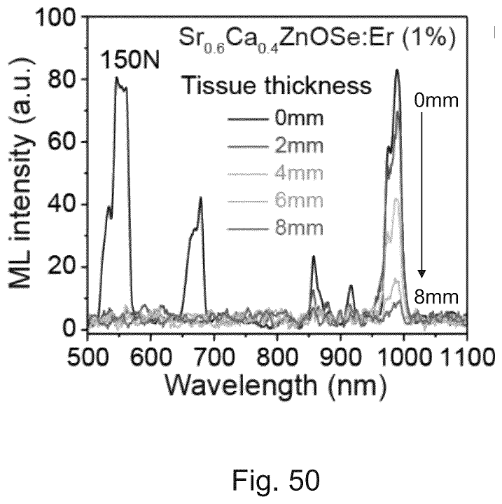

Specifically, an oral cavity model was employed to simulate the biological environment and integrated Sr_{0.6}Ca_{0.4}ZnOSe crystals into a mouthguard for light generation by biting. The mouthguard was composed of transparent and non-toxic ethylene vinyl acetate (EVA) copolymer, and the Sr_{0.6}Ca_{0.4}ZnOSe:Nd³⁺ crystals were sealed in the mouthguard with PDMS (FIG. 47). It is noted that a large particle size of the ML crystals is conductive to effectively receive the bite force. The measurements show that the composite mouthguard rendered intense NIR emission under mechanical stress of 30 N. In this condition, the characteristic peaks of Nd³⁺ could be detected through tissues with a thickness of up to 8 mm (FIGS. 48 and 49). In contrast, the visible emissions of the mouthguard comprising Sr_{0.6}Ca_{0.4}ZnOSe:Er³⁺ crystals hardly penetrated through 2 mm thick tissues (FIG. 50).

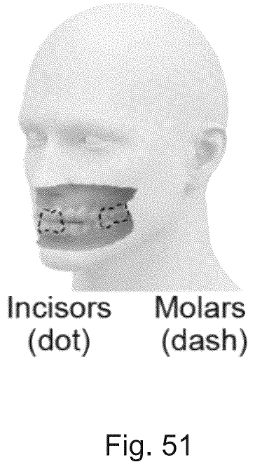

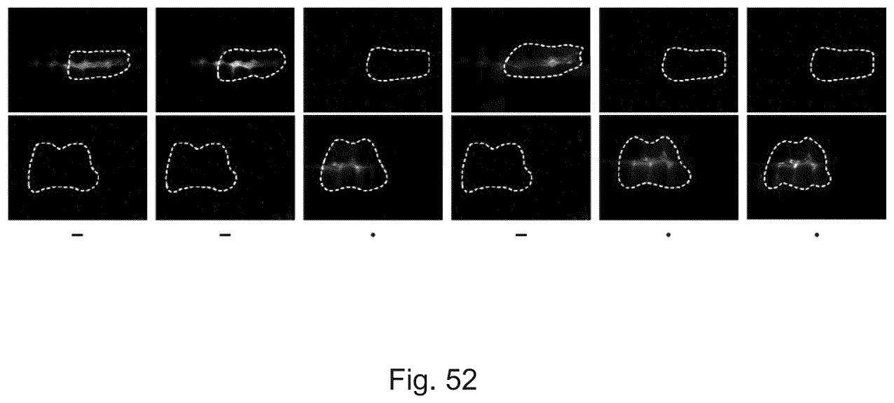

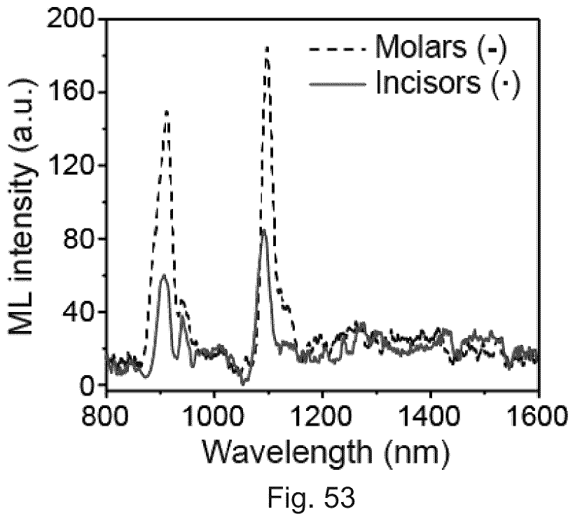

It is shown that the transmission of complex information could be achieved by biting into prescribed patterns. In this way, a sequence of emission pulses could be recorded and interpreted as Morse codes. For example, the NIR signals generated by the molars and incisors in the human oral cavity could be resolved as dash (-) and dot (·), respectively (FIG. 51). Owing to the self-recovery nature of the ML, a series of Morse codes could be continuously generated for transmitting text messages, such as “M (- -)” and “L (·-··)”, and the signals could be readily distinguished by external NIR camera and spectrometer (FIGS. 52 and 53). Since NIR signals are invisible to the naked eye, it is believed that this form of communication can readily achieve information encryption. On a separate note, the demonstration also highlights the possibility of real-time visualization of dynamic mechanical processes in biological tissues.

The invention has been given by way of example only, and various other modifications of and/or alterations to the described embodiment may be made by persons skilled in the art without departing from the scope of the invention as specified in the appended claims.

1. An alkaline earth metal-based complex oxide having a general formula of AEZnOSe, wherein AE represents alkaline earth metals comprising Sr and Ca.

2. The alkaline earth metal-based complex oxide as claimed in claim 1, wherein AE represents SrₓCa₁₋ₓ, with x being an atomic ratio and 0<x<1.

3. The alkaline earth metal-based complex oxide as claimed in claim 2, wherein 0.01≤x≤0.99.

4. The alkaline earth metal-based complex oxide as claimed in claim 2, wherein 0.4≤x≤0.6.

5. The alkaline earth metal-based complex oxide as claimed in claim 4, wherein the SrₓCa₁₋ₓZnOSe with 0.4≤x≤0.6 has a single-phase crystal structure.

6. The alkaline earth metal-based complex oxide as claimed in claim 4, wherein the SrₓCa₁₋ₓZnOSe with 0.4≤x≤0.6 has a non-centrosymmetric hexagonal lattice with a space group of P6₃mc.

7. The alkaline earth metal-based complex oxide as claimed in claim 4 having a formula selected from the group consisting of: Sr_{0.4}Ca_{0.6}ZnOSe, Sr_{0.45}Ca_{0.55}ZnOSe, Sr_{0.5}Ca_{0.5}ZnOSe, Sr_{0.55}Ca_{0.45}ZnOSe, and Sr_{0.6}Ca_{0.4}ZnOSe.

8. The alkaline earth metal-based complex oxide as claimed in claim 4 having an average particle size of about 25 μm to about 30 μm.

9. The alkaline earth metal-based complex oxide as claimed in claim 4, wherein the SrₓCa₁₋ₓZnOSe with 0.4≤x≤0.6 is doped with a lanthanide ion dopant.

10. The alkaline earth metal-based complex oxide as claimed in claim 9, wherein the SrₓCa₁₋ₓZnOSe with 0.4≤x≤0.6 is a host for receiving the lanthanide ion dopant.

11. The alkaline earth metal-based complex oxide as claimed in claim 9, wherein the lanthanide ion doped SrₓCa₁₋ₓZnOSe with 0.43≤x≤0.6 has a non-centrosymmetric hexagonal lattice.

12. The alkaline earth metal-based complex oxide as claimed in claim 9, wherein the SrₓCa₁₋ₓZnOSe with 0.4≤x≤0.6 is doped with about 0.2 mol % to about 1 mol % of the lanthanide ion dopant.

13. The alkaline earth metal-based complex oxide as claimed in claim 9, wherein the lanthanide ion dopant is selected from the group consisting of Nd³⁺, Yb³⁺, Er³⁺, Tm³⁺, Pr³⁺, Tb³⁺, Ho³⁺, Dy³⁺, and Sm³⁺.

14. The alkaline earth metal-based complex oxide as claimed in claim 9, wherein the lanthanide ion dopant is a NIR-emitting lanthanide ion dopant.

15. The alkaline earth metal-based complex oxide as claimed in claim 14, wherein the NIR-emitting lanthanide ion dopant is selected from the group consisting of Nd³⁺, Yb³⁺, Er³⁺, Tm³⁺.

16. A method for preparing the SrₓCa₁₋ₓZnOSe as claimed in claim 2, comprising the step of reacting SrCO₃ and CaCO₃ and ZnSe in a solid-state reaction.

17. The method as claimed in claim 16, wherein the SrCO₃ and CaCO₃ are calcinated to form an intermediate comprising a Sr(Ca)O solid solution.

18. The method as claimed in claim 17, wherein the intermediate is formed in-situ by calcinating a mixture of ZnSe, SrCO₃ and CaCO₃.

19. The method as claimed in claim 18, wherein the mixture of ZnSe, SrCO₃ and CaCO₃ is calcinated at about 1000 °C to about 1350 °C for about 1 hour to about 4 hours, with a heating rate of about 5 °C min⁻¹ to about 10 °C min⁻¹.

20. The method as claimed in claim 16, wherein SrCO₃ and CaCO₃ are calcinated to form an intermediate and the intermediate is calcinated with ZnSe to form SrₓCa₁₋ₓZnOSe, where 0.01≤x≤0.99.

21. The method as claimed in claim 20, wherein the SrCO₃ and CaCO₃ are calcinated at about 1000 °C to about 1350 °C for about 1 hour to about 4 hours.

22. The method as claimed in claim 20, wherein the intermediate and ZnSe are calcinated at about 1000 °C to about 1350 °C for about 1 hour to about 4 hours, with a heating rate of about 5 °C min⁻¹ to about 10 °C min⁻¹.

23. The method as claimed in claim 16, wherein the solid-state reaction is performed without a fluxing agent.

24. The method as claimed in claim 20, wherein x is ≥0.4 and ≤0.6.

25. The method as claimed in claim 16, wherein the ZnSe, SrCO₃, CaCO₃, and an oxide of a lanthanide ion are calcinated to form a lanthanide-doped SrₓCa₁₋ₓZnOSe, where 0.4≤x≤0.6.

26. The method as claimed in claim 25, wherein the lanthanide ion is selected from the group consisting of Nd³⁺, Yb³⁺, Er³⁺, Tm³⁺, Pr³⁺, Tb³⁺, Ho³⁺, Dy³⁺, and Sm³⁺.

27. The method as claimed in claim 25, wherein the lanthanide ion has a concentration of about 0.2 mol % to about 1 mol %.

28. The method as claimed in claim 25, wherein the mixture of ZnSe, SrCO₃ CaCO₃, and the oxide of the lanthanide ion is calcinated at about 1000 °C to about 1350 °C for about 1 hour to about 4 hours, with a heating rate of about 5 °C min⁻¹ to about 10 °C min⁻¹.

29. A luminescent material that is responsive to multiple stimuli, comprising a host including an alkaline earth metal-based complex oxide having a general formula of AEZnOSe, wherein AE represents alkaline earth metals comprising Sr and Ca; and the host is doped with a lanthanide ion dopant.

30. The luminescent material as claimed in claim 29, wherein AEZnOSe is SrₓCa₁₋ₓZnOSe, where 0.4≤x≤0.6.

31. The luminescent material as claimed in claim 29, wherein the host and the dopant has a formula of Sr_{0.6}Ca_{0.4}ZnOSe:Ln³⁺.

32. The luminescent material as claimed in claim 31, wherein Ln³⁺ is selected from the group consisting of Nd³⁺, Yb³⁺, Er³⁺, Tm³⁺, Pr³⁺, Tb³⁺, Ho³⁺, Dy³⁺, and Sm³⁺.

33. The luminescent material as claimed in claim 29, wherein the alkaline earth metal-based complex oxide comprises SrₓCa₁₋ₓZnOSe which is doped with about 0.2 mol % to about 1 mol % of the Nd³⁺.

34. The luminescent material as claimed in claim 29, wherein the alkaline earth metal-based complex oxide comprises SrₓCa₁₋ₓZnOSe which is doped with Ln³⁺ generates photoluminescence at about 480 nm to about 1540 nm in response to radiation stimuli at about 350 nm to about 360 nm.

35. The luminescent material as claimed in claim 31, wherein the Sr_{0.6}Ca_{0.4}ZnOSe:Ln³⁺ is encapsulated by a transparent material selected from the group consisting of PET, PDMS, DBP, and a combination thereof.

36. The luminescent material as claimed in claim 35, wherein the Sr_{0.6}Ca_{0.4}ZnOSe:Ln³⁺ being encapsulated by the transparent material generates mechanoluminescence at about 480 nm to about 1540 nm in response to applied mechanical force of about 5 N to about 55 N.

37. The luminescent material as claimed in claim 36, wherein intensity of the mechanoluminescence is positively proportional to the applied mechanical force.

38. The luminescent material as claimed in claim 36, wherein the mechanoluminescence is detectable through a biological tissue with a thickness of about 2 mm to about 8 mm.
